(19) United States
(12) Patent Application Publication
(10) Pub. No.: US 2012/0123951 A1
(43) Pub. Date: May 17, 2012

(54) SERVICE MANAGEMENT PLATFORM FOR FLEET OF ASSETS

(75) Inventors: Richard Michael HYATT, Glen Allen, VA (US); Satish Joshi, Glen Allen, VA (US); Nagendran Parasu, Glen Allen, VA (US); Robert Hewes, Glen Allen, VA (US)

(73) Assignee: Decisiv Inc., Glen Allen, VA (US)

(21) Appl. No.: 13/297,863

(22) Filed: Nov. 16, 2011

Related U.S. Application Data
(60) Provisional application No. 61/414,691, filed on Nov. 17, 2010.

(51) Int. Cl. G06Q 10/08

(52) U.S. Cl. 705/305

(57) ABSTRACT

A system for managing a plurality of assets and a plurality of parties related to those assets includes a plurality of data sources with information related to the parties and the service of the assets and a first service management server. The service management server may be configured as first and second servers with different functionalities. The service management server, or the first and second service management servers, is configured to collect the data from the plurality of data sources related to the parties and the service of the assets; and is configured to determine maintenance or service requirements for the assets, collect and distribute asset specific data for managing the service requirements of the assets, facilitate communication between parties to a service event, and maintain current and historical data about the service event.

### CROSS REFERENCE TO RELATED APPLICATION

This application claims the benefit under 35 USC 119(e) of U.S. Provisional Application No. 61/414,691, filed Nov. 17, 2010, the entirety of which is incorporated herein by reference.

### FIELD OF THE DISCLOSURE

This relates to a platform for managing a collection of assets, and more particularly, to cost-effective and efficient service management including inspection, repair and maintenance of the collection of assets.

### BACKGROUND

Timely and effective repair and maintenance of assets are important parts of operating a successful business. For example, in the transportation industry, efficient and timely inspection of vehicles in a fleet of vehicles, as well as effective maintenance scheduling and timely and cost-effective repair of the vehicles, are important parts of operating a business. For owners and managers of a fleet of vehicles, such as trucks or cars, performing inspections and completing maintenance and repair requirements in a timely and consistent fashion results in lower costs and greater vehicle efficiency. Fleet owners may often develop certain processes and procedures for maintenance and repair of their vehicles over time to keep their vehicles operating efficiently. However, managing such processes and procedures across hundreds or even thousands of inspections, maintenance, and repair transactions taking place in various locations across the fleet's footprint is a not an easy task. In particular, providing or obtaining a consistent level of service, customized to the specific needs and requirements of the fleet, is a challenge not easily realized.

In addition to asset owners and managers, the parts and services providers that need to be involved in the service management of the asset also have a difficult task in providing goods and services to asset owners and managers consistently and effectively. The increasing complexity of assets, asset systems, asset components and subcomponents, the shortages of skilled technicians in various industries, and service processes that are complicated by separate silos of information from manufacturers and component suppliers, all lead to frustrated customers, as well as lost revenues for parts and service providers.

Another problem in the service process stems from lack of efficient communication between the asset owners, service providers, product and part manufacturers and dealers. For example, vehicle manufacturers often recommend, or even require, a service plan to help improve the performance and durability of their vehicles. Absent sufficient communication between the vehicle manufacturers and the service locations, the service locations may provide service that is inconsistent with the manufacturers' recommended service process. This lack of communication becomes particularly problematic when the vehicle has particular service requirements that the service location is unaware of. Also, repair facility personnel often rely on component information from a variety of sources, each standing as a silo of information with little or no integration to the service process or vehicle being repaired. As a result, component suppliers invest valuable time and resources to develop instructional and promotional material for the parts and components that rarely get referenced because of these process inefficiencies. Also, the inability to quickly gather part numbers, service labor hours, and fleet information, often results in technicians' loss of productivity. Inevitably, technicians may at times begin repairs without a complete picture of expected labor hours, best practices and procedures, service bulletins and more.

### SUMMARY

To overcome the deficiencies of the conventional management systems described above, a service management platform is provided for efficient management of inspection, repair, maintenance and/or other service of a collection of assets that facilitates access to information regarding the assets, such as service plans for the assets. The service management platform can be employed for any collection of assets that require service such as, for example, office computers and equipment, factory machinery, military weapons, etc. The embodiments described herein refer to a fleet of vehicles as the collection of assets managed and maintained by the service management platform. However, these explanatory embodiments should not be construed to limit the disclosure to a platform for the management of only vehicle assets.

The term “collection of assets” can refer to a fleet of vehicles which may, for example, include trucks managed by a trucking company, car rentals managed by a rental company, commuter buses managed by a local transportation agency, etc. The service management platform can include a service management server coupled to a database that holds a vast array of information regarding the collection of assets. The service management server can also be coupled via a network such as the Internet to computers in a number of participating entity locations including, for example, the fleet owner/manager office, service providers such as inspection/repair/maintenance stations, tow facilities, fuel stations, parts dealers, parts manufacturers, and vehicle manufacturers, all of which can provide and receive information concerning a particular asset via the service management server. All information access, delivery, retrieval and presentation can be in-context relative to a specific asset. That is, all asset-related data can be specifically tagged with and driven by a particular asset, and can be pulled into the platform from external data sources in real-time. All information concerning a particular asset and its associated asset-specific information can be maintained in an asset profile which can be available to all platform participants according to permissions set by the asset owner.

All communications, transactions, and information concerning a particular asset service such as repair, inspection or maintenance, for example, and parts lists, estimates, invoices, pictures, etc, can be maintained in an electronic service event folder, specific to that particular service event for that particular asset. Moreover, all communications concerning a service transaction can be maintained in a time-threaded communication file linked to and accessible from the service event folder.

In an embodiment in which the collection of assets includes a fleet of vehicles, the fleet owner/manager can register the vehicles in the fleet with the service management server, including up-to-date information regarding the vehicle. Examples of such information include the Vehicle Identification Number (VIN), mileage, location, etc. The service management server can then complement the information received from the fleet owner with additional information from the vehicle manufacturer. Examples of such additional information include a manufacturer's recommended service plan, manufacturer warranties, manufacturer's part lists, manufacturer's recommended part suppliers, etc. The obtained vehicle information can be stored in the asset profile for future access. Thereafter, the vehicle information can be used to facilitate management of maintenance of the vehicles by the fleet owner/manager. For example, the service management server can send reminders to the fleet owner/manager when inspection, maintenance and/or repair of a particular vehicle becomes due.

In addition, the service management server can provide the fleet owner/manager with information relating to service locations for inspection, repair and/or maintenance of the vehicle. The service locations can be chosen from a database of participating service locations based on, for example, the current location of the vehicle or the type of service provided by the service location. In one embodiment, the service location can provide quotes for the services needed to the fleet owner/manager or for services recommended according to manufacturer recommended maintenance schedules, or for services scheduled to be performed according to the fleet owner/manager's own specifications. According to this embodiment, the fleet owner/manager can review service location options and choose a service location to perform the needed repair or maintenance based on quote amounts, service location, or any other suitable consideration. The fleet owner/manager can also schedule inspection, maintenance and/or repair through the service management server.

When the service management server is accessed by a service provider that has been selected to carry out a particular repair or service, the service management server can provide the service provider with electronic step-by-step repair or service instructions. The service management server can also require the service provider to enter an acknowledgement that one or more steps have been completed before providing additional instructions.

In one embodiment, the service management server can provide to an asset owner or manager, and/or to a service provider, a list of recommended inspections, according to the asset owner/manager's preference. According to this embodiment, the asset owner can select one or more inspections to be carried out for an asset or collection of assets. The asset owner can also configure the service management server to schedule various inspections according to appropriate inspection schedules. In another embodiment, service providers can command the service management server to provide a list of authorized inspections for an asset. According to this embodiment, if a service provider elects to carry out one or more authorized inspections for an asset, the service management server can provide the service provider with a step-by-step inspection protocol, and require input from the service provider as to the status, e.g., “pass,” “fail” and/or “comment”, for each inspection item.

Further, either the fleet owner/manager or the service location can search for and purchase the parts needed for the repair of the vehicle. For example, after the vehicle is delivered to the service location, if the service location does not have a particular part available in stock, it can use the service management platform to request a quote for that part from the participating part dealers and/or part manufacturers. For the purpose of this disclosure, “participating” refers to entities that are participating in the service management platform. The fleet owner/manager can also use the service management platform to directly request the quote from the part dealers and/or part manufacturers. For example, in one embodiment, the fleet owner/manager can develop his/her own estimate of the required services based on their requirements and preventative maintenance schedule and use the service management platform to issue a request for quote to the part manufacturer or dealer of their choice. Participating part dealers may include authorized dealers of the particular part manufacturers, independent part suppliers, part wholesalers, junk yards, etc. In addition to the price, the fleet owner/manager or service location can get access to other information through the service management platform such as, e.g., manufacturer's specification or installation guidelines for the particular part provided by the part manufacturer. Replacement parts identification can be managed by the service management platform using asset and component data and by analysis of manufacturer and component supplier source data for original or remanufactured replacement parts. As part of this management of replacement parts, the service management platform can be configured to identify the availability, cost and location of replacement parts.

According to an embodiment, service management platform can provide a personalized alerts and notification infrastructure to allow each participant to customize what, how and when they receive alerts and status updates. In addition to e-mail, SMS, and platform dashboard alerts, the platform can be configured to provide telephone alerts, voicemail alerts, and any other suitable electronic communication alerts known to persons of ordinary skill in the art. The service management platform can be deployed over private networks and public distributed networks, including the Internet, and can be implemented using known cloud computing techniques.

Communication between service event participants can be managed by the service management platform in the context of the event. Participants may include asset owner, maintenance manager, manufacturer representatives, part suppliers, service providers for example. Any party to a service event managed by the service management platform can add participants to the communication process managed by the service management platform as needed.

Service providers can be managed by the service management platform and selected in accordance with the service management platform or by a participant to the service event and can be specific to the asset, type of service event, location of the asset, ratings based on surveys managed by the service management platform.

Service event surveys can be managed by the service management platform and presented to service event participants based on relevant profiles and data tags. Surveys can rate the service event and be added to the relevant profile. Ratings can be maintained in the profile by the service management platform.

### BRIEF DESCRIPTION OF THE DRAWINGS

FIG. 1 illustrates an example of a network architecture in accordance with one embodiment.

FIG. 2 illustrates an example of a process flow in accordance with one embodiment.

FIGS. 3A-33 illustrate examples of user interfaces in accordance with embodiments.

FIG. 34 illustrates an example of computing device in accordance with one embodiment.

### DETAILED DESCRIPTION

Embodiments of the present disclosure provide a platform that manages the service of a collection of assets. While the embodiments described herein refer to a fleet of vehicles as the collection of assets managed by the platform, it should be understood that the platform can apply to any collection of assets that require service such as, for example, office computers and equipment, factory machinery, military weapons, etc.

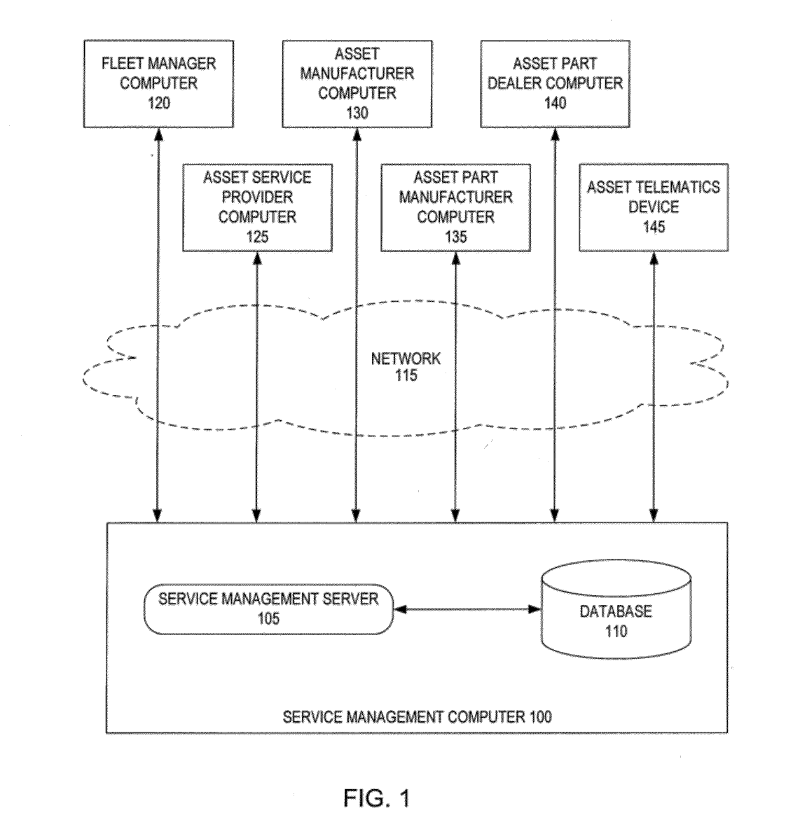

FIG. 1 illustrates an example of a network architecture in accordance with one embodiment. As shown in FIG. 1, the service management platform can be deployed on service management computer 100 and include service management server 105 coupled to database 110. Service management server 105 can also be coupled, through network 115, to fleet manager computer 120, asset service provider computer 125, asset manufacturer computer 130, assert part manufacturer computer 135, assert part dealer computer 140 and asset telematics device 145—all of which can be associated with a particular asset of the fleet owner or manager maintained by the platform. In this embodiment, fleet manager computer 120 can be associated with an owner or manager of a fleet of vehicles; asset service provider computer 125 can be associated with, for example, a towing service, an inspection station, a service/repair station, or a fuel station; asset manufacturer computer 130 can be associated with a vehicle manufacturer; assert part manufacturer computer 135 can be associated with a manufacturer of vehicle parts or components; and assert part dealer computer 140 can be associated with a dealer of parts or components.

It is also noted that while FIG. 1 depicts only one of each of these computing devices coupled to service management server 105, a potentially large number of each type of computing device (e.g., other assert server provider computers, asset manufacturer computers, assert part manufacturer computers and assert part dealer computer) associated with a particular asset of the fleet owner or manager can be coupled to service management server 105. Further, any number of participating computers can also be coupled to the platform, such as a service or distribution network associated with one or more assets or fleet owners in the platform.

Each of fleet manager computer 120, asset service provider computer 125, asset manufacturer computer 130, assert part manufacturer computer 135, assert part dealer computer 140 and any other participating computer may be any device that can send or receive information and/or communicate with service management server 105 over network 115. Network 115 can be a private network or may be implemented using the Internet or other public network. While each of these computing devices may be embodied as a standalone computer that includes a processor and a computer-readable medium encompassing a computer program that, once executed by the processor, allows a user to communicate with, they are not so limited. The devices may also be embodied as access devices other than standalone computers, including—but not limited to—smart phones, cellular phones, tablets, and other suitable electronic communication devices.

Fleet computer and/or access device 120 can be used by a fleet owner or manager to manage the service of the vehicles. Examples of such vehicles includes, but is not limited to, commercial trucks, commuter buses, school buses, rental automobiles, rental RVs, etc., or a combination thereof. The fleet owner may own or operate as little as a one or as many as several thousand vehicles within the fleet. The vehicles within the fleet need to be inspected, serviced, and repaired on a regular basis. The fleet owner can perform its own service and repair or may outsource the task of service and repair to an outside service provider. The service provider can use service management server 105 to locate and obtain the parts necessary for repair and maintenance of the vehicle.

In one embodiment, service management server 105 can obtain information relevant to the vehicles in the fleet from fleet owner computer 120 and store that information in database 110. Such information can include, for example, the make, model, Vehicle Identification Number (VIN), mileage, use, location, driver, and other information related to the vehicle. Service management server 105 can also obtain information relevant to the vehicles in the fleet from asset manufacturer computer 130. That information can then be stored in a database or used in “real-time” by service management server 105.

Database 110 can be a relational database identifying each vehicle by its VIN number or another unique number (i.e., a tag) generated for the vehicle. The tag can identify vehicle specific attributes such as, but not limited to, engine serial number, engine size, transmission type, type of oil used, etc. The tag can also identify administrative attributes such as, for example, the state in which the vehicle is registered, vehicle warranty information, account number, cold weather application, the name of the person responsible for approving repair, etc. The tag can be used to group the vehicles of a fleet together for the purpose of access and management by the fleet owner. Database 110 can also include a unique identifier for identifying the particular fleet owner. The fleet owner/manager may register this information with service management server 105, which can then store the information in database 110. The service management platform can use asset and component tags as well as service histories of the assets to identify possible warranty coverage for replacement parts and to alert the user of such coverage. The platform can be configured to provide access to manufacturer and replacement part warranty coverage information stored in database 110 or provide access to such information over network 115 through the platform to the servers of the manufacturers or parts suppliers.

Database 110 can also include the service information associated with the vehicles in the fleet. The service information can include, for example, the manufacturer's recommended service process, the dealer's recommended service process, the owner's preferred service process, the date of last visit, the location of last visit, services performed during the last visit, the date of next scheduled visit, the services scheduled for the next visit, special notes for the next visit, etc. In addition, database 110 can include information relating to the parts for the vehicle such as, for example, the owner's preferred parts supplier and the dealer's recommended parts supplier. Using database 110, service management server 105 can provide virtually all the information needed to perform efficient service of any vehicle within the fleet of the owner's vehicles.

The platform can provide all information access, delivery, retrieval and presentation in-context relative to a specific asset. That is, all asset-related data can be specifically tagged with and driven by a particular asset, and can be pulled into the platform from external data sources (e.g., databases associated with computers 125, 130, 135 and 140 and device 145) in real-time during the processes described herein via pre-defined application programming interfaces associated with the external data sources. All information concerning a particular asset and its associated asset-specific information can be maintained in an asset profile stored on database 110 and can be available to all platform participants according to permissions set by the asset owner.

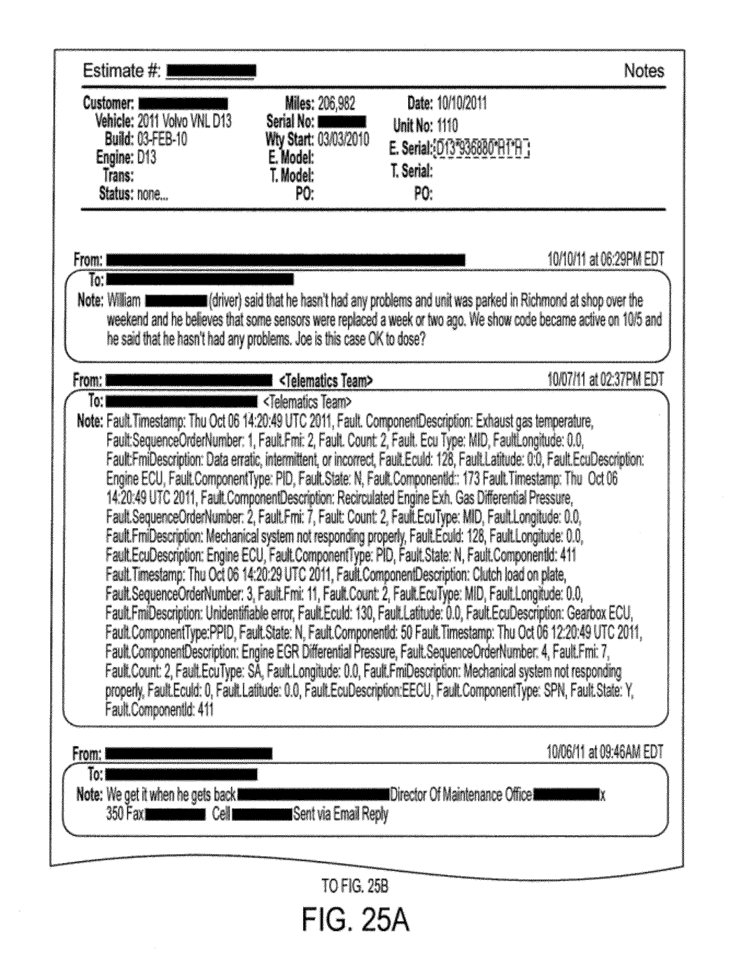

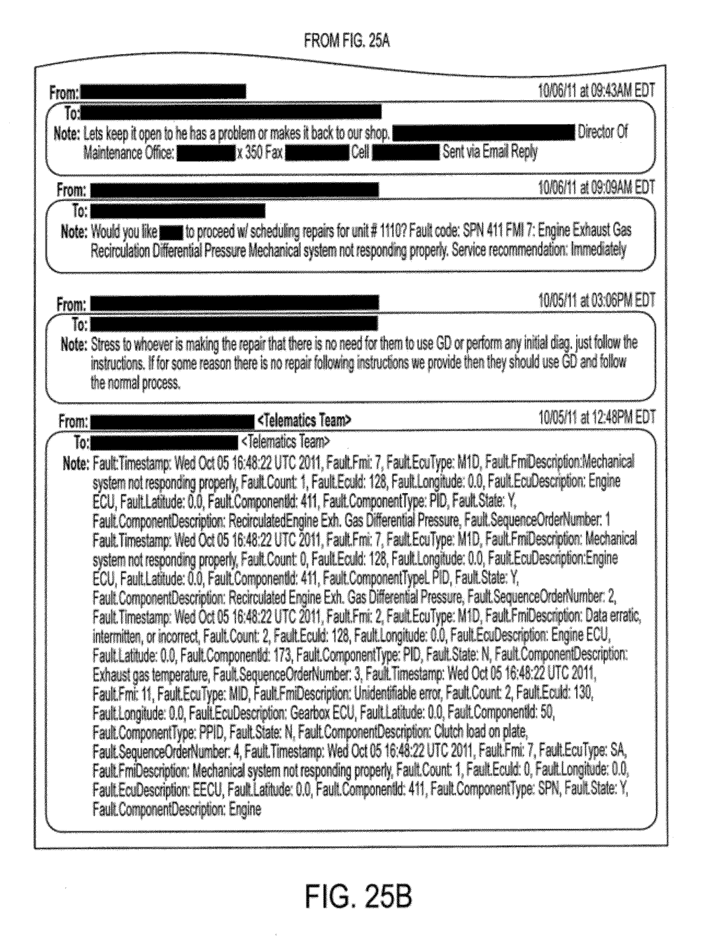

All communications, transactions, and information concerning a particular asset service such as repair, inspection or maintenance, parts lists, estimates, invoices, pictures, etc, can be maintained in an electronic service event folder, specific to that particular service event for that particular asset. Moreover, all communications concerning a service transaction—even those provided using different communication modes such as the platform, e-mail and SMS—can be maintained in a single time-threaded communication file linked to and accessible from the service event folder. As described below, FIGS. 25A-25B illustrate an example of a time-threaded communication facilitated by service management server 105. The service management platform can be configured to provide alerts, notifications and access to any device that may be used to access the internet, and the interface may be configured to be specific to the device. Examples include: browser based handheld devices such as droid, iPhone, MS Windows Mobile; and even a standard cell “dumb” phone.

Service management server 105 can also receive information such as telematics from asset telematics device 145 such as an asset's onboard diagnostic computer/processor, or from a participating onboard computer management server that receives such information from a collection of asset telematics devices and distributes such information appropriately. Service management server 105 can receive information concerning faults or other status information detected and/or maintained by asset telematics devices as well as the location of the asset. Service management server 105 can add this information to the asset profile, open a new service event and send alerts to various participants according to configurations set by the asset owner.

Service management server 105 can be configured to initiate service events based on initiation by an asset owner, access to the asset owner's asset management system, input to the platform from a telematics device on an asset, fault or other information provided to the platform, point of service identification through scanning of asset identification markers or other identifiers such as an RFID tag, and in-context data from the asset pulled into the platform.

In addition to vehicle information, database 110 can also include information relating to service locations (i.e., service providers at a particular location). For example, database 110 can include information relating to the services performed by the service providers along with inventory and pricing information of each service provider. Thus, the platform enables the owner of the fleet to look up the closest participating service provider that carries a certain component in stock, along with pricing information for the component and labor estimates, all through the service management computer 100. In addition, the platform can be configured to identify and recommend one or more providers without requiring additional input from the owner. In one embodiment, service management server 105 can calculate such estimates based on information previously provided by the service provider. For example, asset service provider computer 125 can provide service management server 105 with component prices, hourly labor rate, and the number of labor hours required for various maintenance tasks. Service management server 105 can then use that information to calculate estimates on the spot. In another embodiment, service management server 105 can provide the service provider with a list of components and services needed and request a price estimate. The service provider can then calculate the estimate for labor and parts and forward the estimate to the fleet owner via the service management server 105.

Database 110 can also include information relating to the part manufacturers and/or part dealers. For example, database 110 can include information relating to pricing, availability, rating, special discounts, etc. of parts and components provided by different part manufacturers. Using this information, the fleet owner can, for example, create through service management server 105 a preferred list of parts and components, which can later be used by service locations to obtain the parts needed for the vehicles. Also, through service management server 105, the fleet owner or the service location can place a special order for a part needed for the vehicle directly to the part manufacturer or the part dealer. In that case, all the steps necessary for completing the transaction, including payment processing, can be completed through service management server 105. The part manufacturer can also advertise special deals or discounts to the fleet owners and/or service locations through the service management server 105.

Database 110 can also include information relating to the vehicle manufacturers. Examples of such information can include the manufacturer's recommended service plan, the manufacturer's warranty information, special promotions, etc. Such information can allow a fleet owner and/or service location to perform services on the vehicles in accordance to the vehicle manufacturer's recommendations. Based on the information stored in database 110 described above, service management server 105 allows the fleet owners, service locators, vehicle manufacturers, and part manufacturers, to contribute to providing an efficient vehicle service throughout the life of the vehicle.

Database 110 can also include various local, state, or federal inspection requirements, tax regulations, and other regulatory measures for different types of vehicles. Thus, by associating a vehicle with the state in which the vehicle legally registered, service management server 105 can provide the vehicle with inspection plans and service plans that are consistent with the state's regulations. For example, when the vehicle is taken to a service provider for a mandatory state inspection, that vehicle can be inspected by a service provider using service management server 105 according to the inspection requirements of its home state regardless of its current location.

Service management server 105 can maintain a list of mandatory and/or recommended inspections for each asset in each asset profile, as well as an inspection protocol specific for each asset/inspection combination. In other embodiments, the information can be stored elsewhere (i.e., external to the platform, such as in association with asset manufacturer computer 130) and retrieved by service management server 105 when needed on a real-time basis using in-context access. Inspections can be specific to a particular asset and/or to a particular component or assembly within an asset or class of assets. When an asset arrives at a service provider location and a technician enters asset identifying information into asset service provider computer 125, the asset profile specific to that asset can be retrieved from service management server 105, and the technician can be presented with one or more inspection options. When a particular inspection is selected, an inspection protocol can be presented to the technician. Each specific inspection item can be identified based on component and component location: e.g., headlight, right front. For each component, various inspection options can be presented via a pull-down menu, which may include various failures specific to that component. The technician can also be presented with the opportunity to enter notes, to upload a photograph of the failed component and/or to select a platform-generated repair operation specific to the vehicle and component in question. Inspection failures can be tied to predefined repair plans that get loaded to the case and/or presented to the service writer to select and add.

Inspections can be cloud based, accessed wirelessly, and device independent so that service technicians can perform the inspection and interact with the service management server and the asset profile specific to the asset being inspected via the technicians' own hand-held device. This is advantageous because it enables the technicians to efficiently input results of the inspection into the platform via the hand-held device while they are performing the inspection at the vehicle, removing the extra time and effort otherwise required to return to a desk or counter to enter the results into the platform via a standalone computer.

Upon completion of the inspection, service management server 105 can maintain results in a service event folder in the asset profile for that asset. In addition, if necessary, service management server 105 can place a repair order specific to the asset/inspection failure in the asset profile. If configured by the asset owner, notifications and/or request for quotes concerning the repair order can be sent to participating service providers. The service management platform can also allow manufacturers of vehicles and components to issue notices such as, for example, newsletters, recall notices, part promotions, etc. to the fleet owner as well as dealers and service locations.

In one embodiment, each fleet owner, service location, vehicle manufacturer, and part manufacturer can register an account with service management server 105 to provide a variety of information, as described above, to database 110. The fleet owner can provide the necessary information for each vehicle within the fleet to be managed by service management server 105. Service management server 105 then uses that information to manage the maintenance and inspection scheduling of the vehicles.

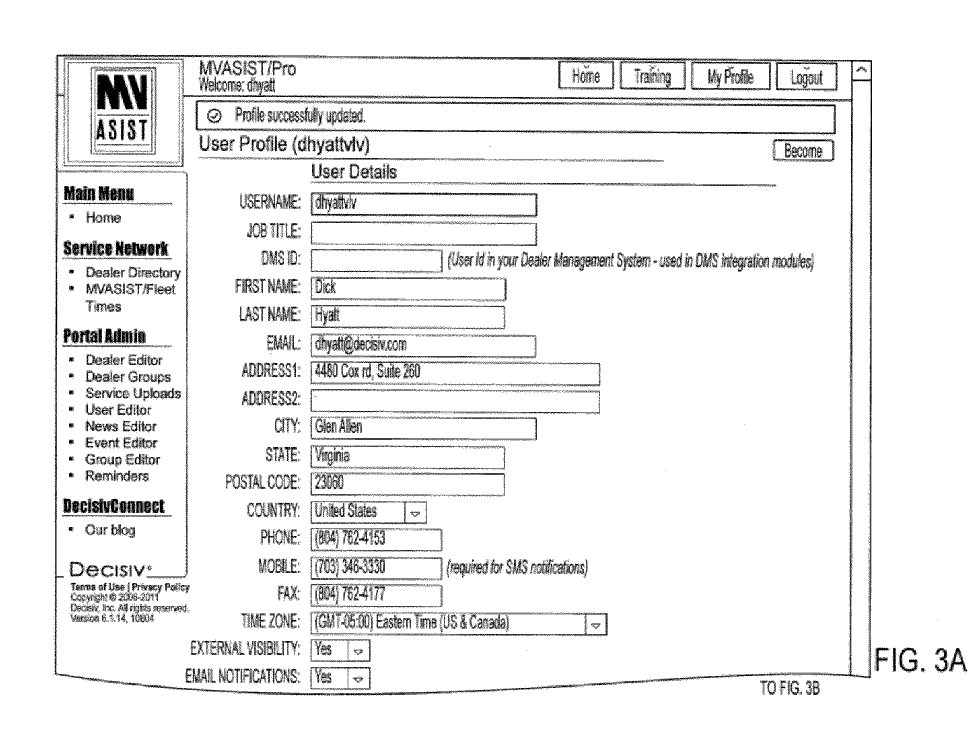

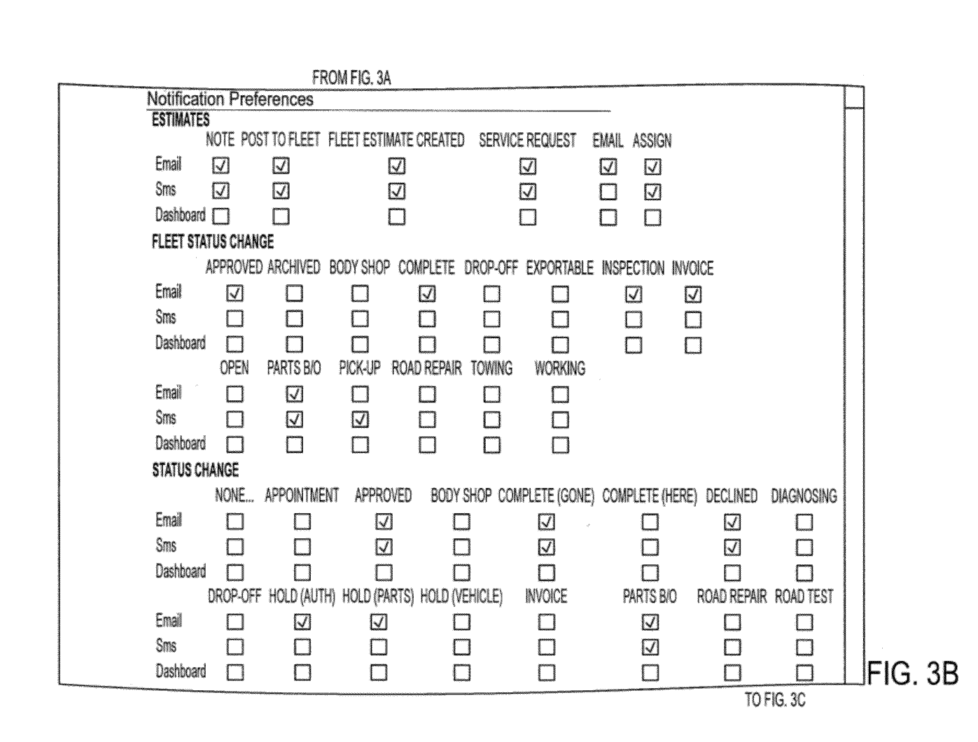

Fleet owner computer 120, asset service provider computer 125, asset manufacturer computer 130, assert part manufacturer computer 135 and any other participating device can each be provided with a graphical user interface (GUI), allowing a user to access database 110 via service management server 105. The GUI can be, for example, a software program executed on the respective computers, or can be executed via service management server 105 through an Internet browser of the respective computers. Through the GUI, the users can be allowed to add, delete, or edit information in the platform. For example, through the GUI on fleet owner computer 120, the fleet owner can add, delete or edit vehicle information, set up preferred list of part manufacturers, specify geographic preferences for vehicle maintenance, manage vehicle maintenance, etc. As described below, FIGS. 3A-33 illustrate examples of GUIs for different computers that use the service management platform.

In one embodiment, the service management platform can also enable a 3rd party services company (like AAA) to be a service provider wherein the subscriber to the service calls a number and turns the repair or service requirement over to the 3rd party service provider's call center. In this embodiment service management server 105 can provide the case management tools for managing the event via the 3rd party service provider's computer (similar to asset service provider computer 125)—tools such as finding, requesting and managing the tow, the service/repair and any sublets while connecting the 3rd party service provider's call center with all other connected parties through the platform as depicted in FIG. 1.

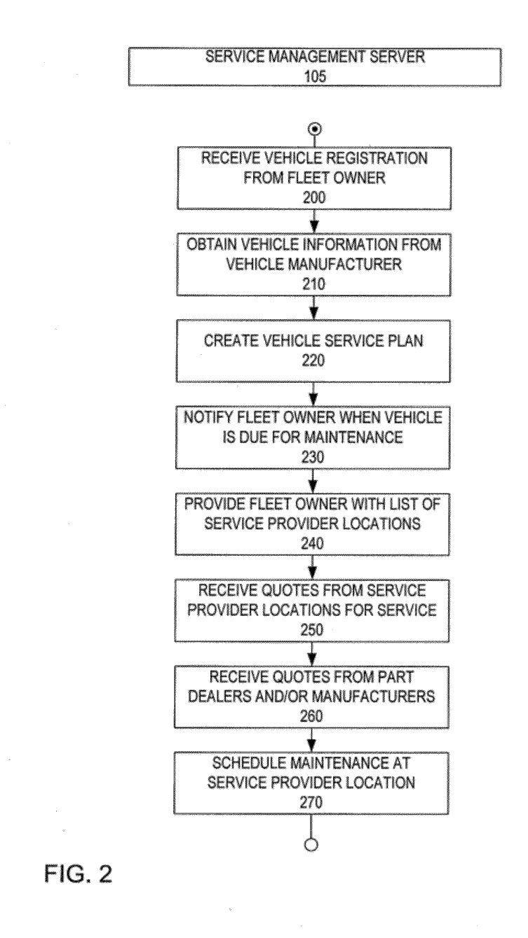

FIG. 2 illustrates an example of a process flow in accordance with one embodiment. In the illustrated embodiment, service management server 105 can receive vehicle information from the fleet owner during or after the registration process (block 200). For example, as previously described, the fleet owner or manager can open an account with service management server 105 and provide a listing of all the vehicles in the fleet along with information such as make, model, mileage, location, etc., to service management server 105. The fleet owner or manager can also periodically update the existing vehicles information and add new information as new vehicles are added to the fleet.

Service management server 105 can also obtain vehicle information from the vehicle manufacturer (block 210). In one embodiment, database 110 may include a listing of all vehicle makes/models along with information provided by the vehicle manufacturer, which is often publicly available. In another embodiment, the vehicle manufacturer may directly provide information regarding the vehicles to the service management server 105. As previously discussed, such information can include the manufacturer's recommended service plan, vehicle specifications, manufacturer warranty, etc.

Once all the needed information is obtained, service management server 105 can then create a service plan for the vehicle (block 220). The service plan can include, for example, a recommended service schedule specifying the types of service required for the vehicle. The service plan can be created based on plan preferences received from the owner, the available service plans provided by the service locations within the geographic preferences of the owner, and the recommended service plan received from the vehicle manufacturer. The service plan can then be stored in database 110 for the vehicle. Thereafter, based on the service plan, service management server 105 can send a reminder to the fleet owner/ manager that the vehicle is due for maintenance (block 230). This can be done in any suitable manner, such as an email reminder to the owner, an alert or a flag on the GUI on fleet manager computer 120, or an alert or notification to a mobile device.

The fleet owner/ manager can also be provided with a listing of the service locations that can be used for service of the vehicle (block 240). Service management server 105 can choose the service locations from database 110 including participating service locations based on, for example, the current location of the vehicle or the type of service provided by the service location. In one embodiment, service management server 105 can inquire as to the current location of the vehicle from the fleet owner/ manager and provide a recommended list of service locations based on the received location.

Using the list of service locations, service management server 105 can then allow the owner to request quotes from each of the dealers and/or service locations for the parts and/or services needed in accordance with the service plan (block 250). Service management server 105 can then forward the details of the parts and/or services needed to the dealers and/or service locations and request a quote from the service locations. In one embodiment, the fleet owner/manager can come up with his/her own requirements and preventative maintenance schedule and issue through the service management platform a request for quote to the dealers or service provider of their choice. In another embodiment, service management server 105 can receive and store pricing information from each of the service locations in advance and, upon receiving a quote request from the owner, may directly calculate an estimate for the services to be performed.

When a request for quote is received by the service location through the platform, the service location can provide a quote based on its available inventory or request pricing for the needed parts from a part manufacturer and/or part dealer through the platform. In the latter case, service management server 105 can send the pricing request to various part manufacturers and/or part dealers, who can provide a quote back to the service location through the platform (block 260). Service management server 105 can also receive such pricing information in advance and store it in database 110. In that case, upon receipt of a request from a service location, service management server 105 can calculate a quote based on the price and shipping cost of the item and provide the quote to the service location. The service location can then provide a quote to the fleet owner/manager through the platform. All communication between the fleet owner/manager and the service location can be captured and stored in database 110 for future reference. The owner/manager and the service location can also communicate directly via, for example, email, links to a GUI or service management portal associated with the platform, or alerts or notifications to mobile devices with SMS responses. In yet another embodiment, the fleet owner/ manager can directly request price quotes for the parts from the part manufacturers and/or part dealers outside the platform and update the platform with the quotes.

After receiving a quote from the service location, the fleet owner/ manager can select a service location in the platform to schedule a service (block 270). Service management server 105 can then send a scheduling request to the service location. The dealer can then confirm the requested appointment through the GUI on asset service provider computer 125.

Upon the arrival of the vehicle at the service location, the service location personnel can look up the vehicle information and service plan at asset service provider computer 125 using a browser based access for example. The service location can then provide the necessary service in accordance with the service plan. Thus, for example, the service location can be informed of the services that the vehicle is due for. Also, if there is a note from a previous service location regarding a special problem that needs checkup or a component that needs to be reinstalled, the platform can provide a corresponding notification so that the service location can attend to performing such services. The service location can also order parts needed for the services to be performed on the vehicle from the part manufacturers. Also, if the service location needs access to instructions regarding a particular service, the service location can access such information from database 110.

Once a service is completed the service event folder for that event can be closed by service management server 105 and tagged to the asset profile so that the asset history is complete. The service event folder and associated communications thread can also be exported to asset management software or another system by any participant.

If, for whatever reason, a non-critical repair or maintenance is not performed before an asset needs to be placed back in service, the incomplete service event can be appended to the asset profile with a status identifier set as pending work and can be accessible at any time and invoked at the point of service when asset information is subsequently accessed by the asset owner or by the same or different service provider.

The asset owner can also pay for the services through service management computer 100. Service management server 105 can survey participants at any time during the service process and provide feedback to any participants based on survey responses. Additionally, the platform can be configured to provide alerts and notifications to selected participants based on feedback thresholds, providing an opportunity for a participant to intervene in the service process. Such rating and feedback information can be stored in database 110, which can be viewed by other owners/managers in the future.

The service management platform can also enable the fleet owner/manager to hold an auction for the parts and services needed for the repair and service of the vehicle. For example, using the service management platform the fleet owner can calculate an estimate for the needed repairs and services and use that as the basis for an auction along with an itemized list of needed parts and services. The dealers and service locations can then place bids on the parts and services through the platform. As a result, the fleet owner can receive all the needed parts from various dealers at the lowest price and provide those parts to a service location willing to provide the needed services, also at the lowest price.

FIGS. 3A-33 illustrate examples of GUIs for different computers that use the service management platform.

FIGS. 3A-3C illustrate an example of a user profile screen provided by service management server 105 for a fleet manager. In this example, the user profile allows the fleet manager to specify contact information and to select settings that define the behavior of the service management platform with respect to various actions associated with the assets (e.g., “Volvo Trucks”) managed by the fleet manager through the platform. Upon the fleet owner or manager selecting the “Save Changes” button at the bottom of the illustrated screen, service management server 105 can store the user profile in database 110.

The illustrated user profile screen enables the fleet manager to input user details, notification preferences and administrative notes. The user details that can be input include contact information via multiple different modes of communication, such as the platform (via the “dashboard” or user interface of an application running the platform on a computer or other device), e-mail, phone (e.g., work phone number), SMS (e.g., mobile phone number), and fax. The notification preferences provide contact options of e-mail, sms and dashboard (i.e., the home user interface that the fleet owner views when logged into the platform) when various predefined actions occur with regard to estimates and status changes. The illustrated user profile screen also enables the fleet manager to change a password associated with his/her registered account for logging into the platform.

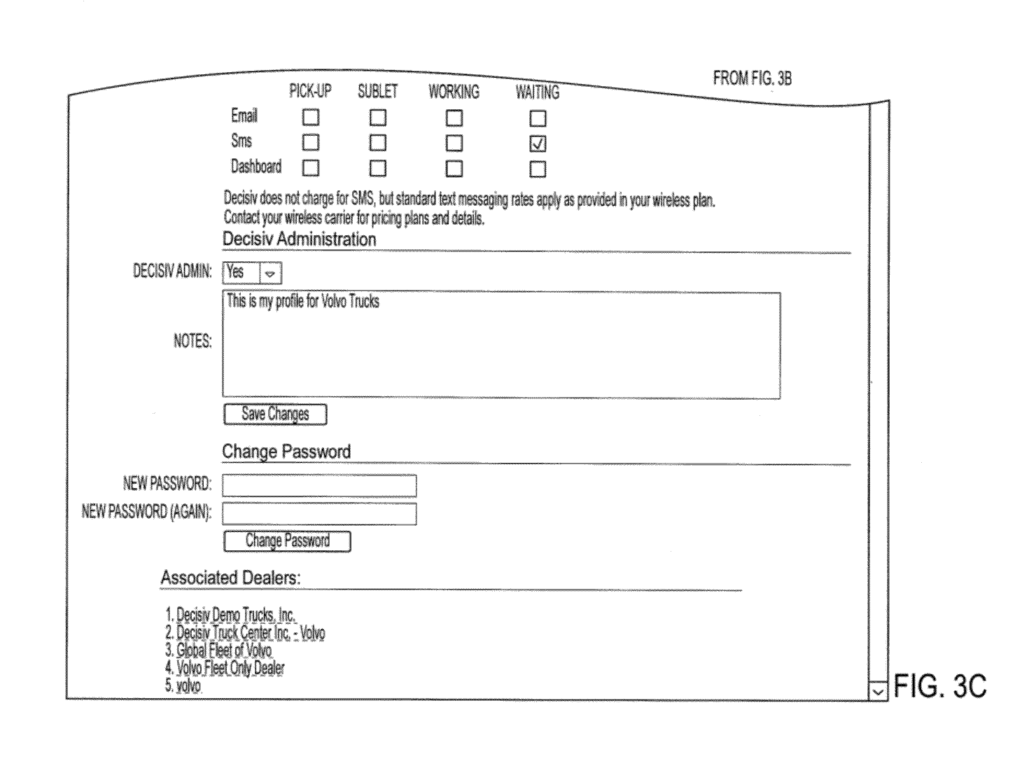

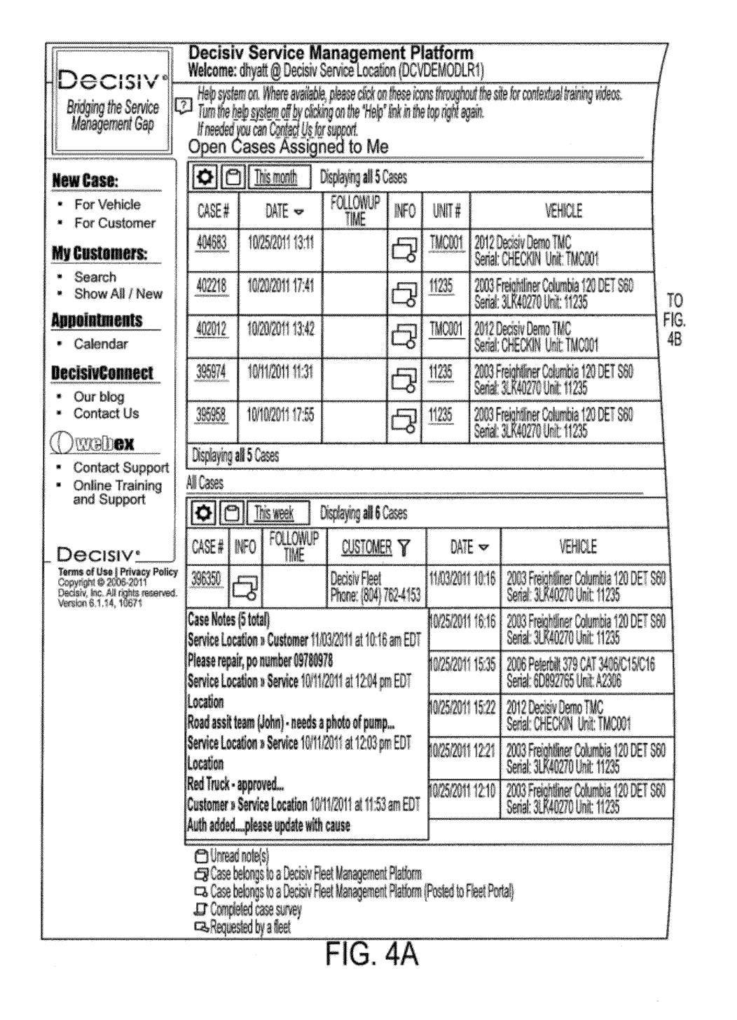

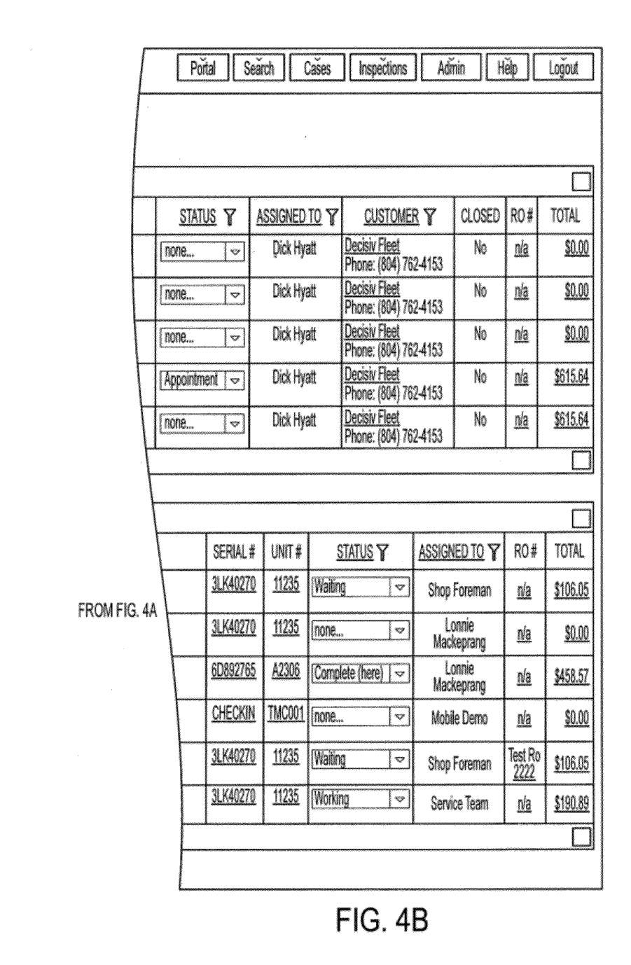

FIGS. 4A-4B illustrate an example of a dashboard provided by service management server 105 for a service provider. In this example, a service provider view of the dashboard displays to a service provider user (e.g., a mechanic or employee of that service provider having an account on the platform) all open service event cases assigned to that particular user as well as all cases assigned to the service provider (including, e.g., those assigned to any other mechanic at that service provider location). These cases can include information regarding customers and their contact information, vehicle identification information including their serial and unit numbers, date and time of the cases, etc. The dashboard can also enable small windows with relevant information to appear when a mouse rolls over a portion of a service event, such as the mouse over window in FIG. 4A depicting “Case Notes” which appears when the mouse rolls over a note icon for a particular service event.

It is noted that any number of accounts can be grouped within a particular type of participant account in the platform. For example, a service provider account can have associated accounts for individual users (e.g., mechanics, administrators, etc) or sub-groups of users (e.g., different teams of mechanics, etc.). These groups can be defined by an administrator through the platform, which can subsequently enable users to identify to which pre-defined group or sub-group to direct communication via the platform.

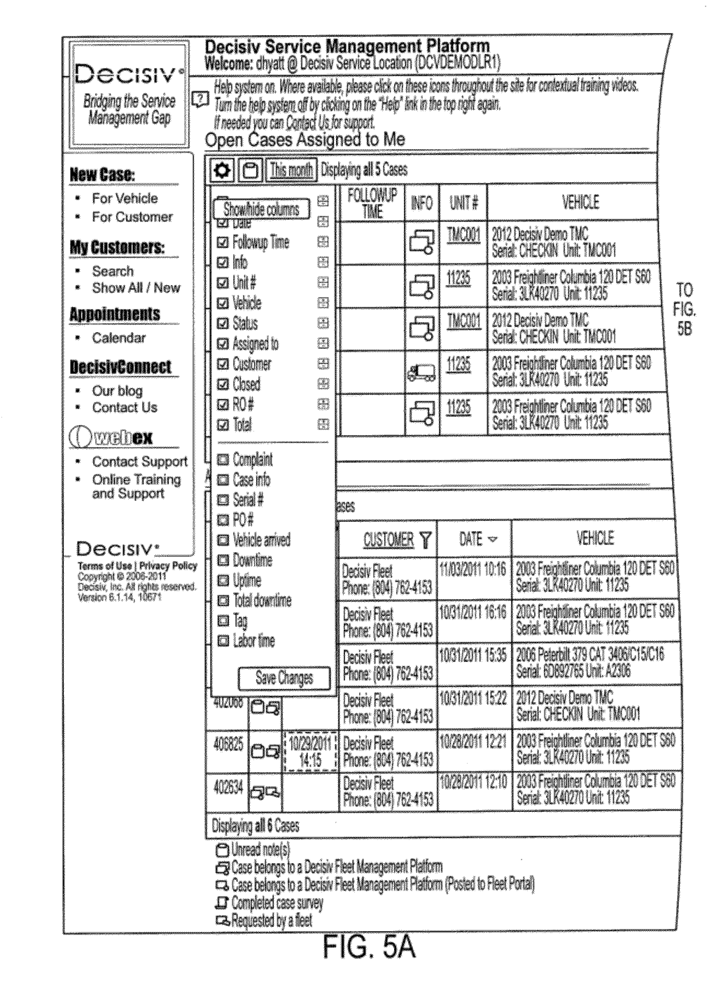

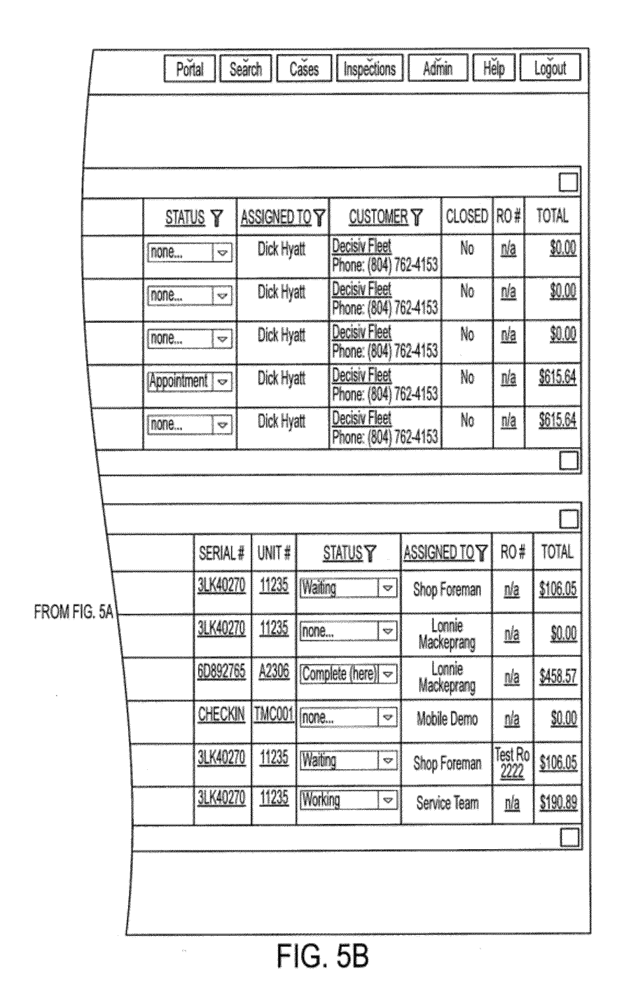

FIGS. 5A-5B illustrate another example of a dashboard provided by service management server 105 for a service provider. In this example, the dashboard displays along the left-hand side column options that can be selected in order to customize the dashboard. The customization can be done with regard to the types of information which is to be displayed upon logging-in of the user. For example, the user can select to display the case number (this option is hidden behind the “Show/hide columns” popup window in the dashboard depicted in FIG. 5A), date, follow-up time, vehicle information, unit number, status, to whom the case has been assigned to, customer information, whether the case has been closed, complaint, case information, serial number, whether the vehicle has arrived, downtime, uptime, total downtime, tag, labor time, etc, but the user can also hide any of these entries by deselecting any of these entries. Further, in this example, the user may be a mechanic / service person but can be any employee of the service provider.

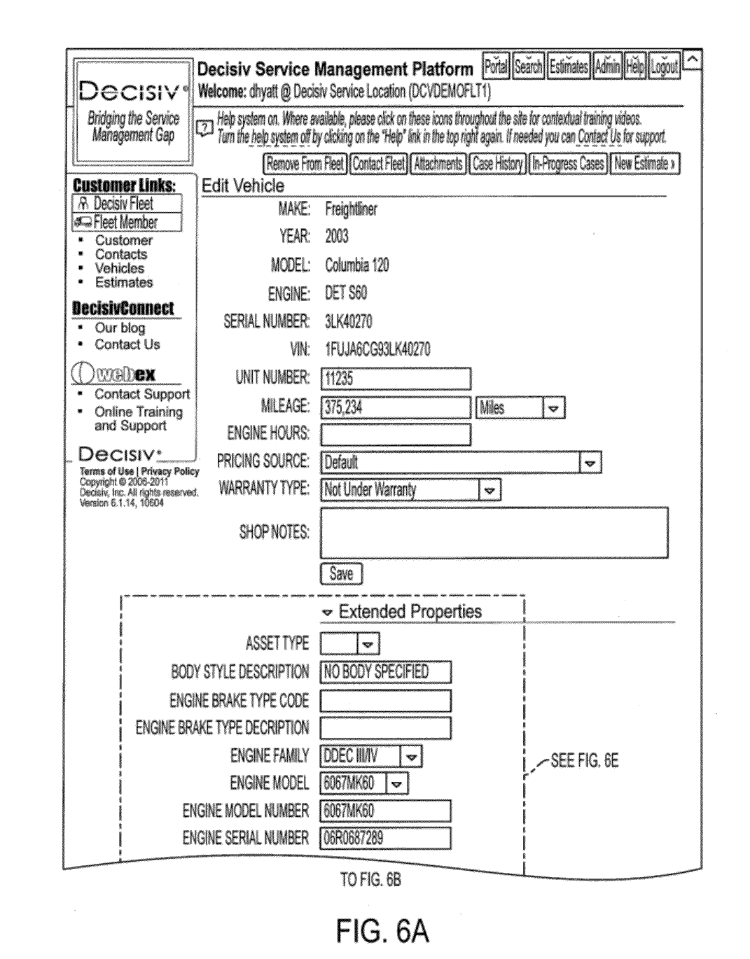

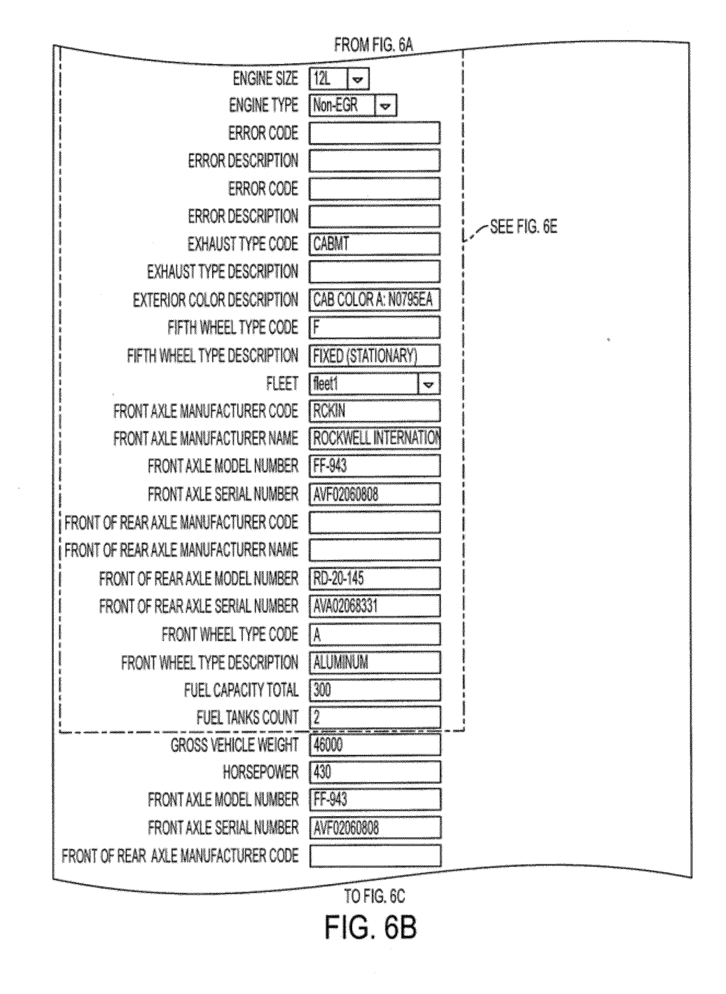

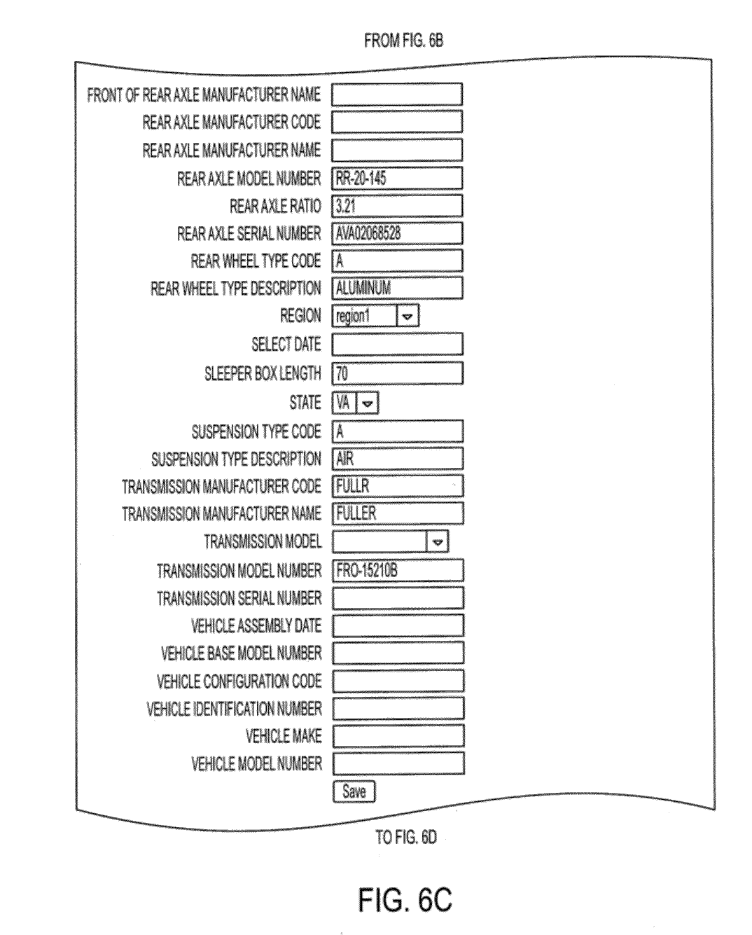

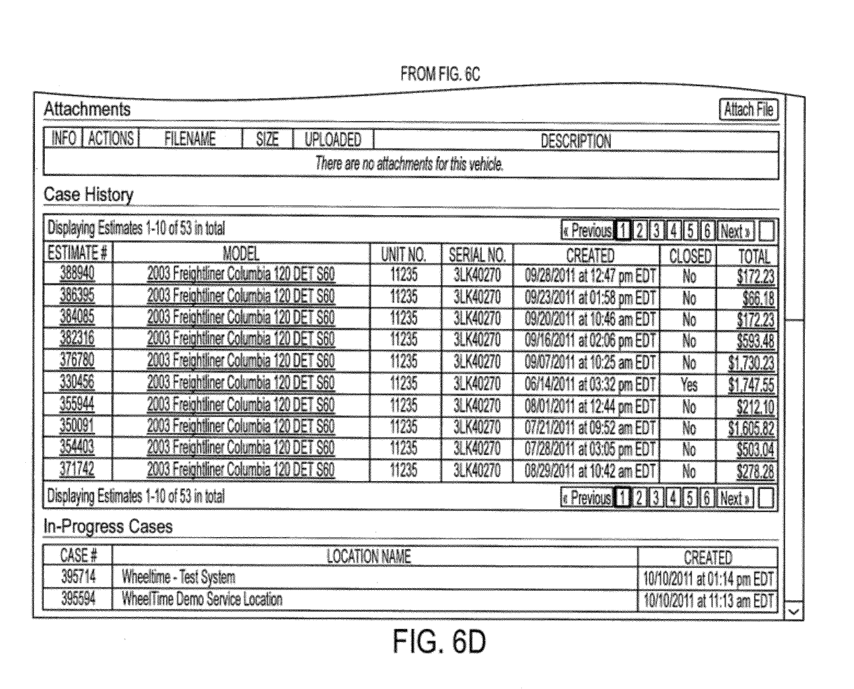

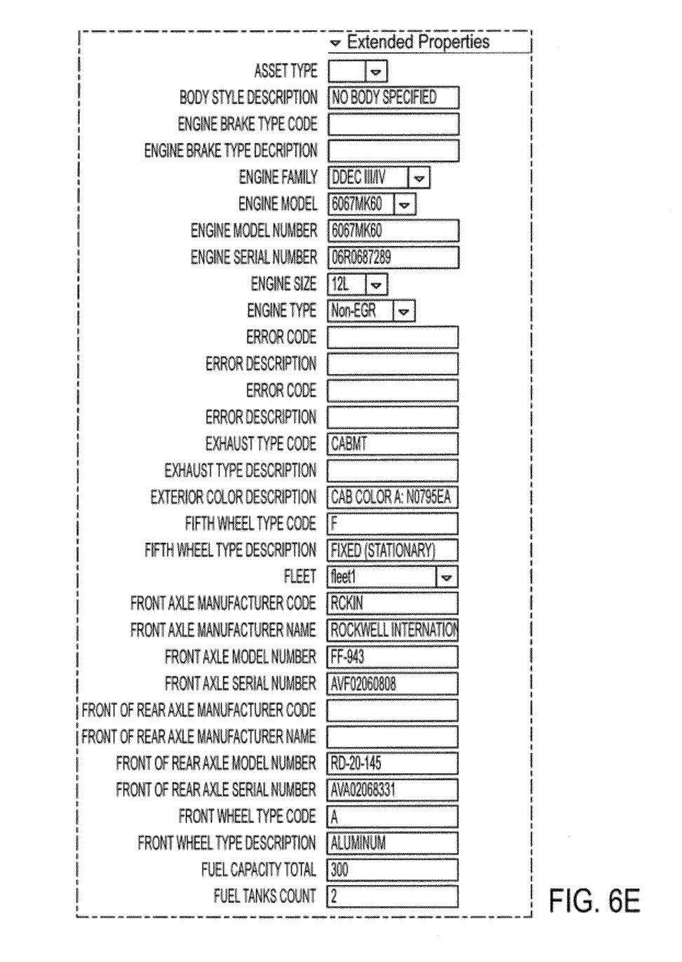

FIGS. 6A-6D illustrate an example of an editable vehicle asset profile provided by service management server 105 along with a cut-out portion (shown in FIG. 6E) of the profile showing some properties of a vehicle provided for illustration purposes. In this example, the vehicle asset profile allows a user (e.g., fleet manager) to manage a vehicle/asset profile and specify the type of the asset (i.e. vehicle type, body style description), service schedules (i.e. the asset must be serviced within 90 days), detailed component list associated with the asset, history of past service events and any on-going service events associated with the asset. Further, the vehicle asset profile allows the user to include any attachments in the profile, for example, a warranty document, recalls, contract maintenance coverage document, insurance document, etc.

The illustrated vehicle/asset profile screen can have several auto-populated entries based on a real-time communication between service management server 105 and a third-party entity, such as, an original equipment manufacturer database server. Once the user inputs the basic vehicle identification information, such as, the VIN number, server 105 can relay that information to the original equipment manufacturer database server in order to pull the detailed component list associated with that particular vehicle. This pulled information can be used to auto-populate the component list entries in the profile.

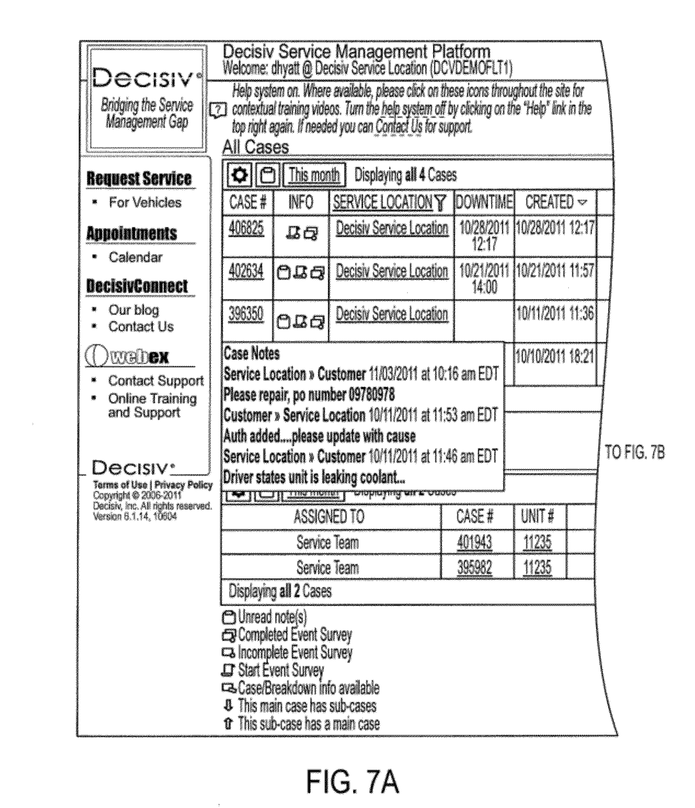

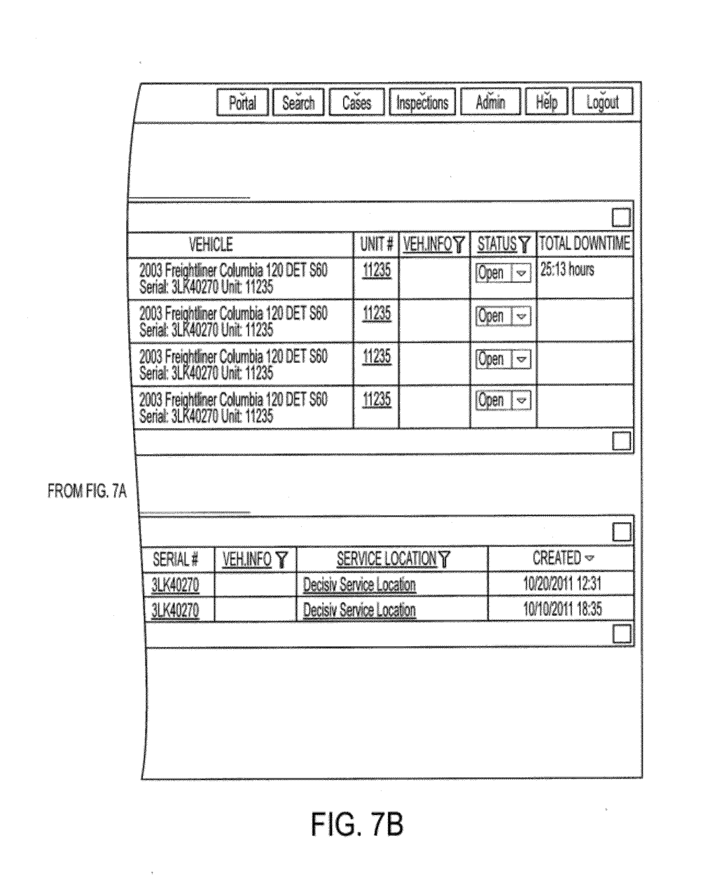

FIGS. 7A-7B illustrate an example of a dashboard provided by service management server 105 for a fleet manager. In this example, the dashboard allows a user to see all open cases for assets owned by or associated with the fleet manager. When a mouse is dragged over a case entry on the dashboard screen, a mouse over window can automatically appear which can include the most recent threaded communications of participants associated with the vehicle. In the dashboard depicted in FIG. 7A, the threaded communications between the service provider and the customer are shown in the mouse over window depicting “Case Notes.” Further, the illustrated screen displays to the user all “Requested Service” cases in a table below the “All Cases” table (the heading “Requested Service” is located above the lower table but hidden behind the “Case Notes” popup window in the dashboard depicted in FIG. 7A). These requested service entries indicate the case number, subject vehicle's unit number, serial number, designated service provider and any other relevant information.

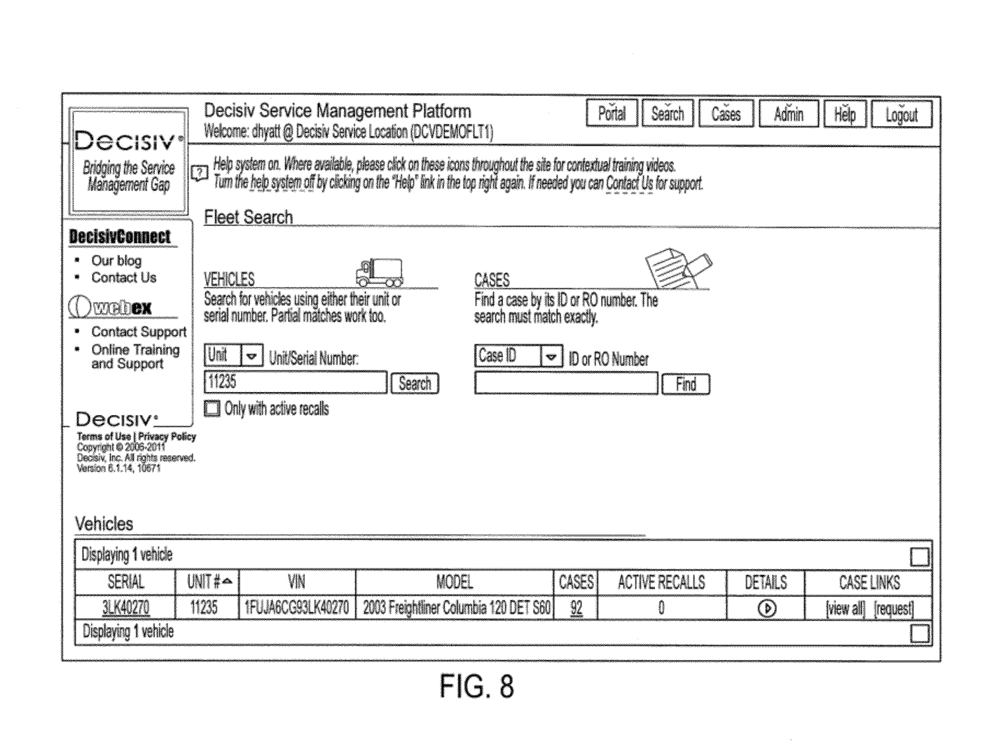

FIG. 8 illustrates an example of searching for an asset on which to initiate a service event by a fleet owner via the platform. In this example, the platform allows a user to search and select a vehicle for which a service event is to be created for that vehicle. The platform allows the user to search the vehicle by the vehicle's unit number, which can be any unique number identifying the vehicle in the platform.

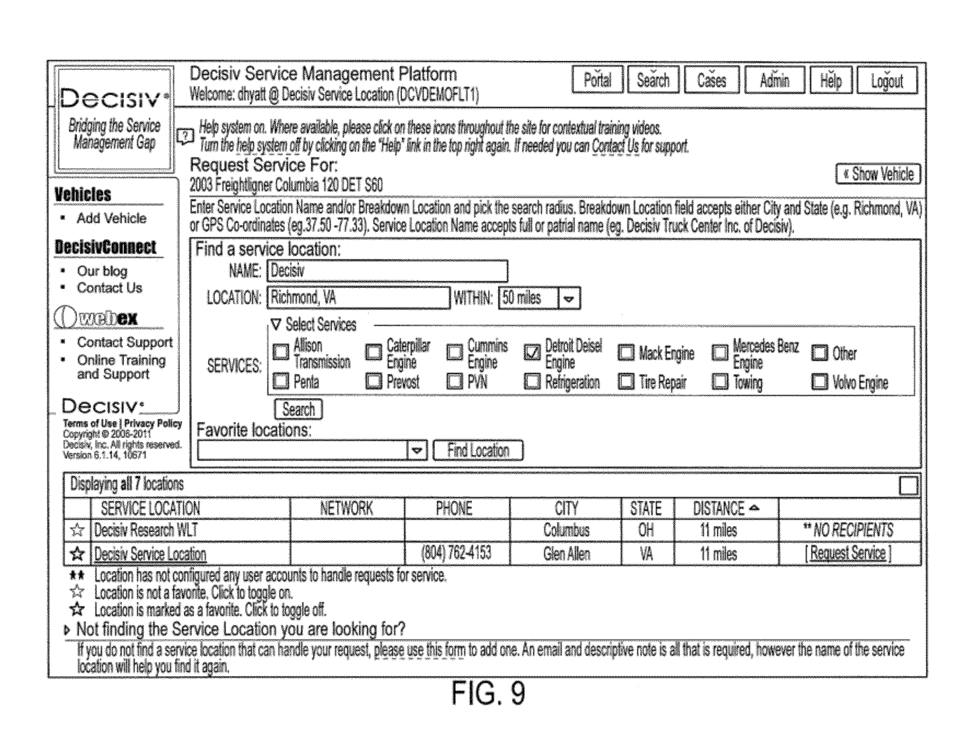

FIG. 9 illustrates an example of identifying a service provider to handle the service event via the platform. In this example, the platform allows a user to search and select a service provider to request service for the selected vehicle discussed above in relation to FIG. 8. The platform allows the user to search the service providers based on their names, locations and available services (i.e. Allison transmission, caterpillar engine, Detroit diesel engine, mach engine, penta, prevost, pvn, refrigeration, tire repair, etc). The platform subsequently displays the service providers and their contact information pulled from database 110 based on the search conditions and allows the user to select one or more service providers among those pulled list.

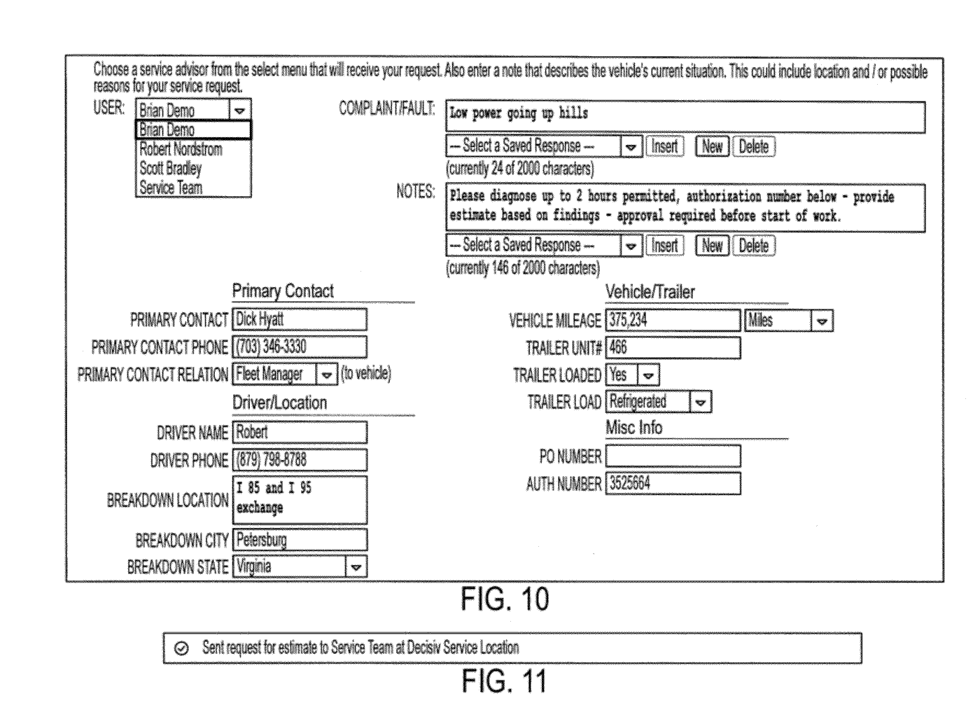

FIG. 10 illustrates an example of selecting a service advisor as part of the service event request via the platform. In this example, the platform allows a user to enter service event information pertaining to the selected vehicle discussed above in relation to FIG. 8. The platform can allow the user to specify a service advisor that will receive the current service event request and enter a note describing the vehicle's current condition or any other relevant information to be reviewed by the service advisor. The drop down list next to “USER:” indicates different user groups (e.g., Brian Demo, Robert Nordstrom, Scott Bradley, Service Team) associated with a particular service provided that can be selected to receive the service request. Further, some entries displayed on the dashboard can be auto-populated based on a real-time or static data associated with the vehicle, such as the miles, engine hours, or current location of the vehicle.

FIG. 11 illustrates an example of a confirmation message that can be displayed by the platform to a user once the user sends a service event request as discussed above in relation to FIGS. 8 through 10.

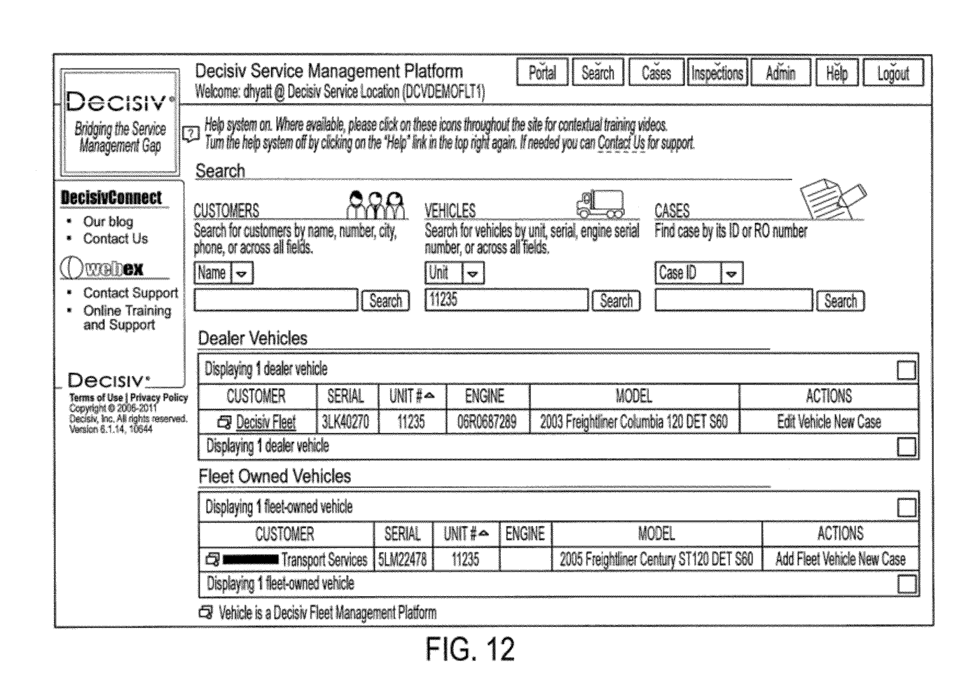

FIG. 12 illustrates an example of searching for an asset on which to initiate a service event by a service provider via the platform. In this example, the platform allows a user to search and select a vehicle upon the vehicle's arrival at the service location. Similar to the user interface provided for a fleet manager, the user interface depicted in FIG. 12 for a service provider allows a user to search the vehicle by its unit number which can be any unique number identifying the vehicle in the platform. The search can also be performed via customer information (i.e. name), vehicle information (i.e. VIN) or case id. The platform returns a list of vehicles matching the parameters searched and allows the user to select the appropriate vehicle.

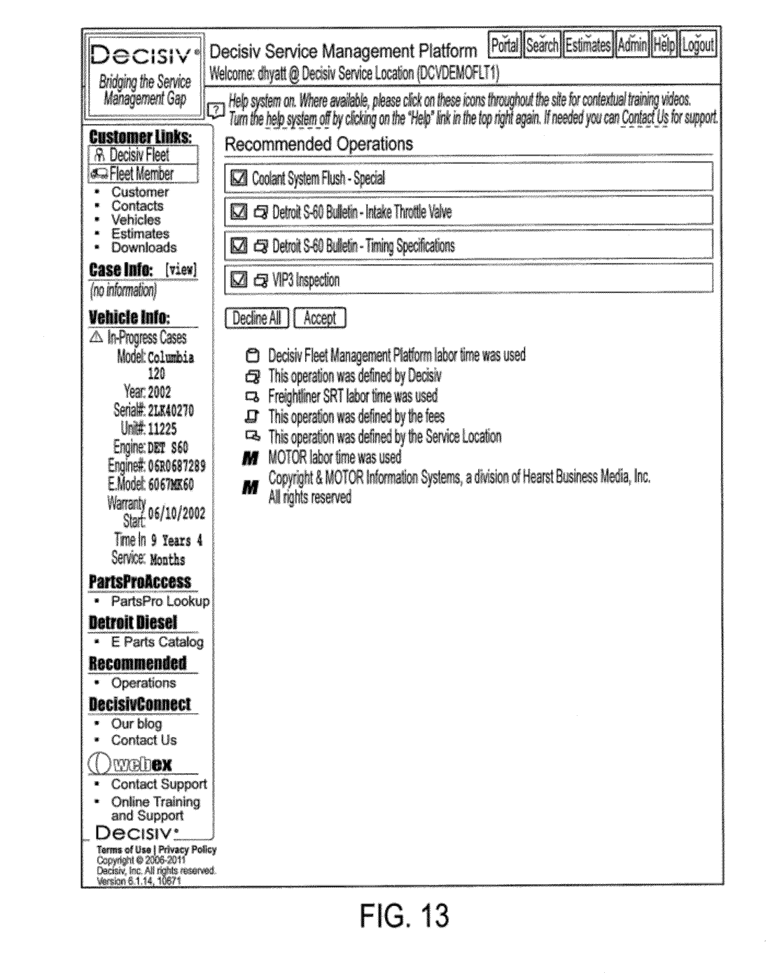

FIG. 13 illustrates an example of recommended operations provided by the platform in response to selection of an asset. In this example, the platform provides a user with recommended operations for the selected vehicle discussed above in relation to FIG. 12. Once the vehicle is selected, service management server 105 can search the asset profile corresponding to the selected vehicle, pull service information from the service provider's profile stored in the server, pull service bulletin operation information from the original equipment (OE) systems, and pull VIP inspection information from the inspection network. It is noted that this is not an exhaustive list of information that service management server 105 can pull internally or externally upon vehicle selection. Rather, service management server 105 can be configured to search and/or pull any other suitable information. Once pulled, the platform displays all of the information obtained by service management server 105.

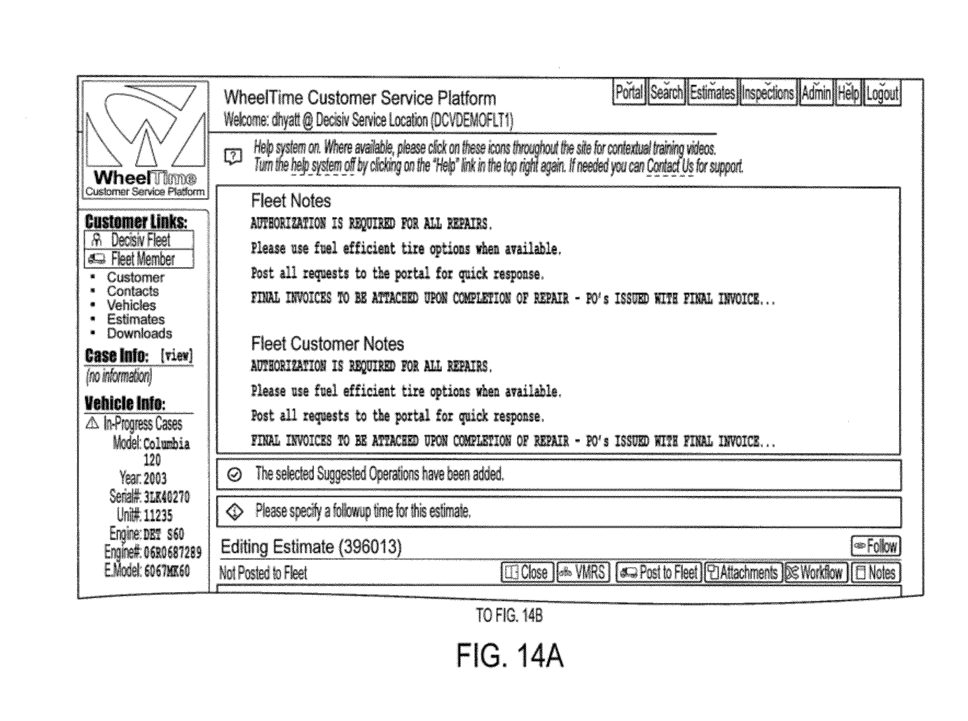

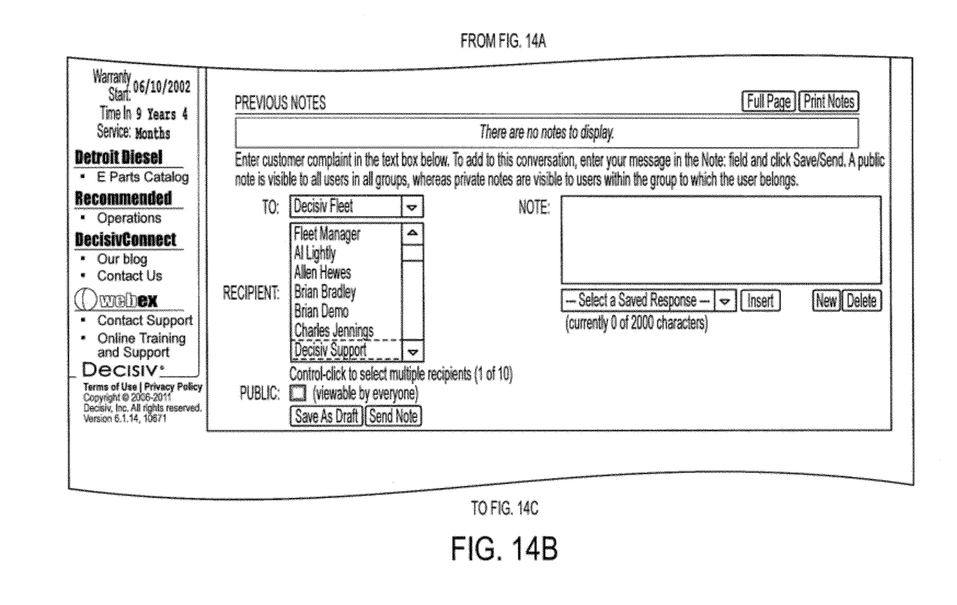

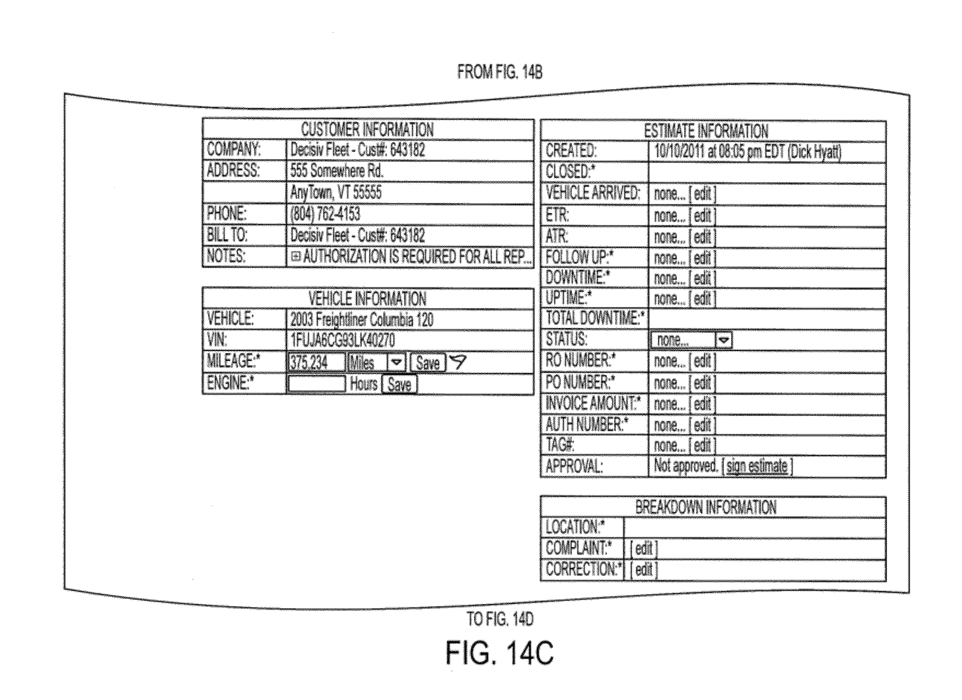

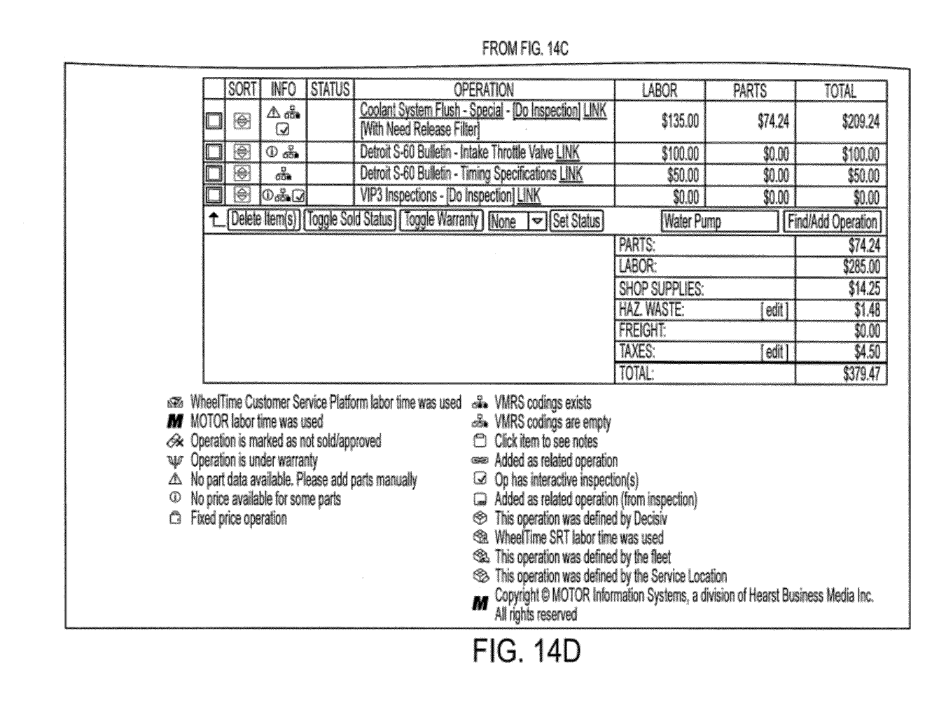

FIGS. 14A-14D illustrate an example of an opened service event for a service provider. In this example, the platform opens the selected service event discussed above in relation to FIG. 13 displaying a list of fleet contacts (e.g., contacts based on VIN groupings for fleet / asset managers) and other fields auto populated from partner systems or profiles (e.g., auto-populated fleet information based on the fleet profile, fleet notes highlighted in box with “Fleet Notes” heading, etc.). It is noted that the platform can include in the opened service event any other suitable information associated with the service event.

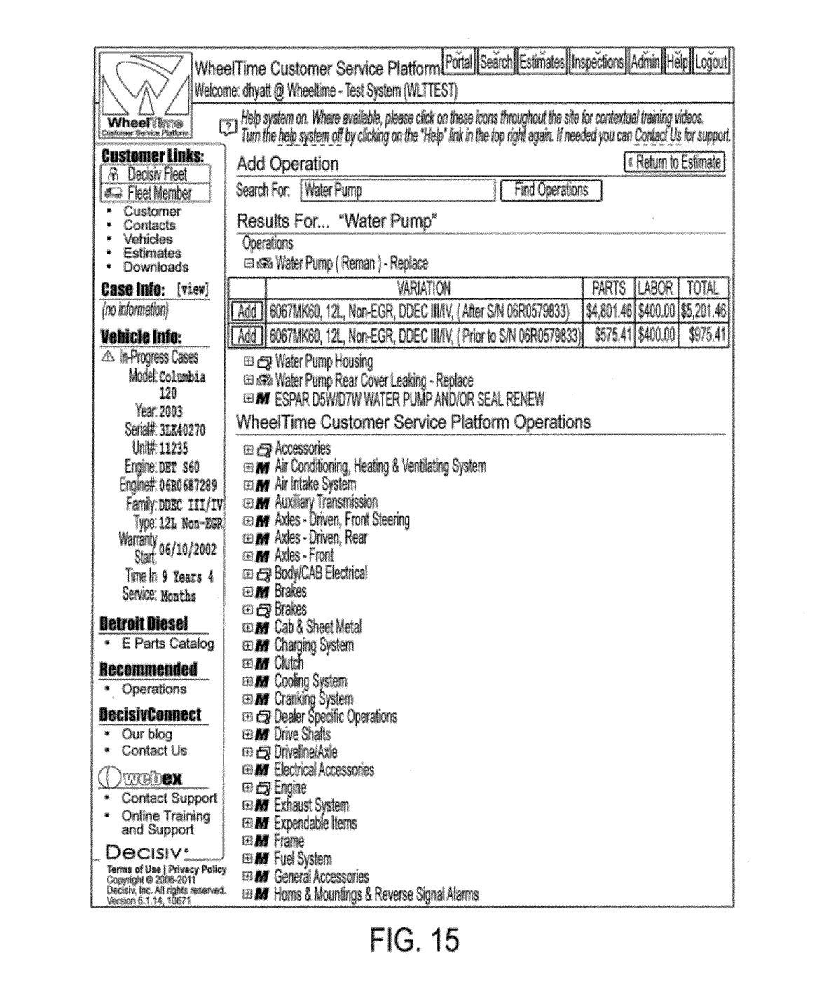

FIG. 15 illustrates an example of adding operations in a service event via the platform. In this example, the platform allows a user to select one or more operations (e.g., pre-defined repair plans) stored in database 110. The operations can be specific to asset component tags, and the operations can be from a third party (Motors), network (WheelTime), OE (warranty and standard repair operations), or local to the service provider location. As depicted in FIG. 15, the platform allows a user to perform a search for operations associated with search terms such as “water pump.”

Operations can be created using the platform in several ways, such as by OE, Network, Fleet or Service Location. The operations can include part(s), part prices (pulled from various sources—network, location, fleet, OE), labor times, skill level, labor rate, description, etc, and variations (e.g., different models) based on vehicle components, serial number ranges, vocational use (dump truck), type of use (heavy duty vs. light use), and many other variables.

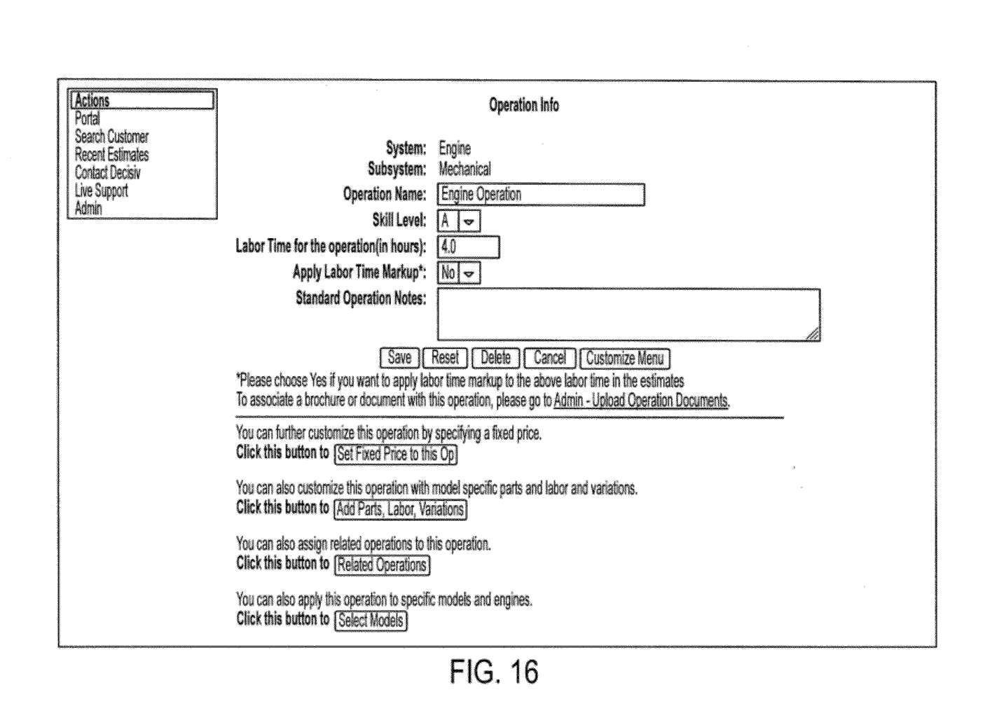

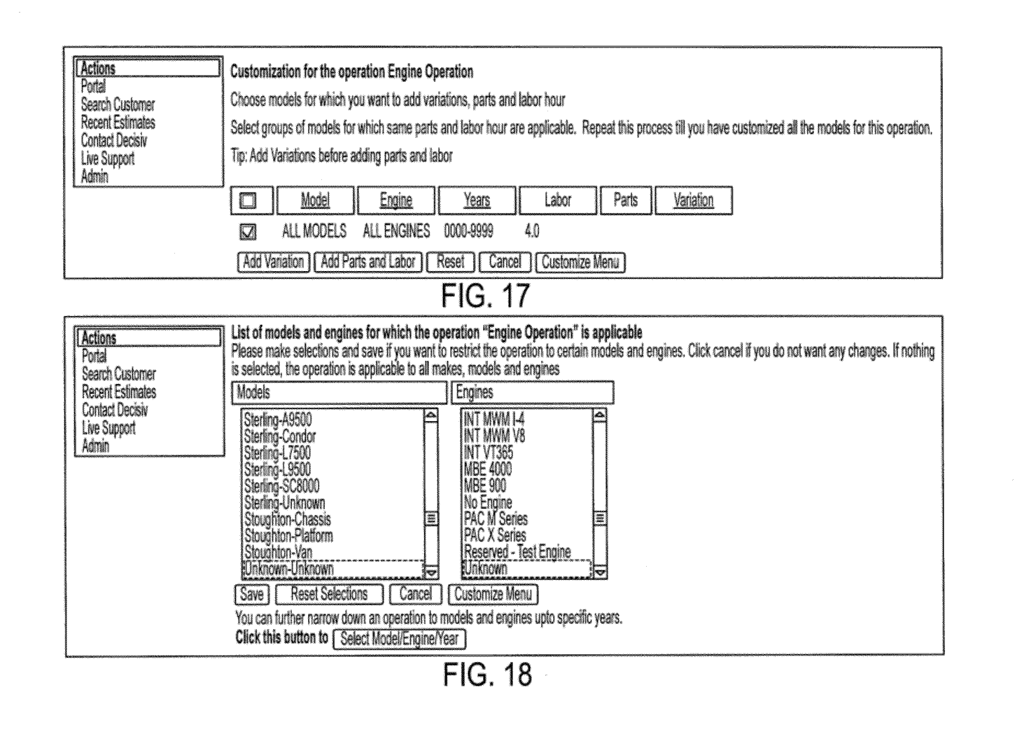

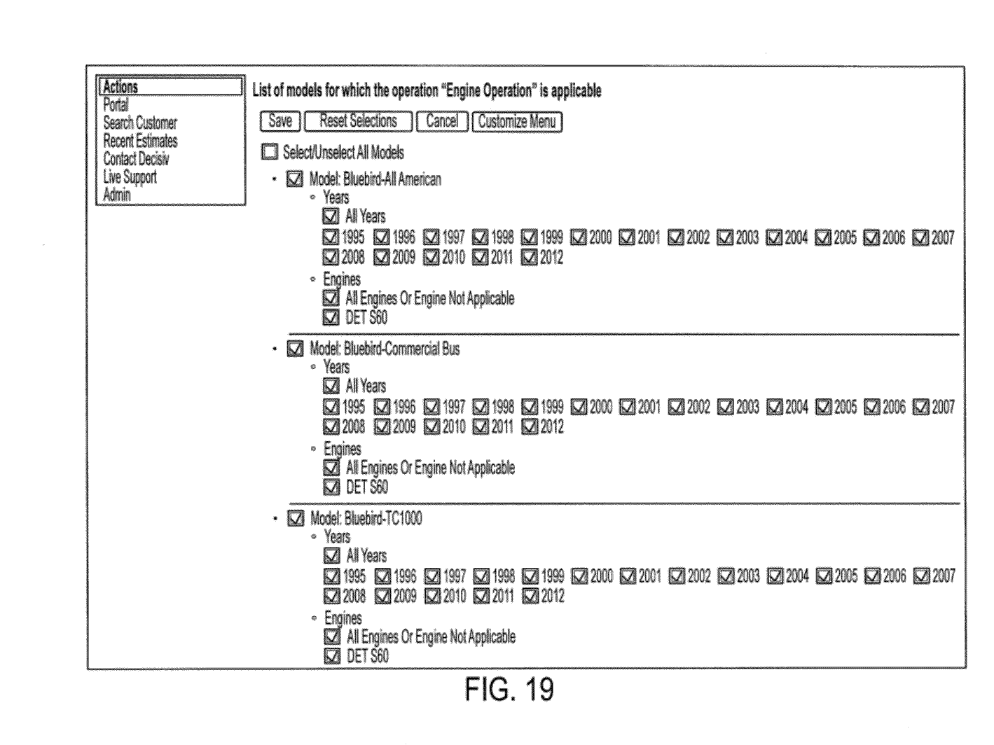

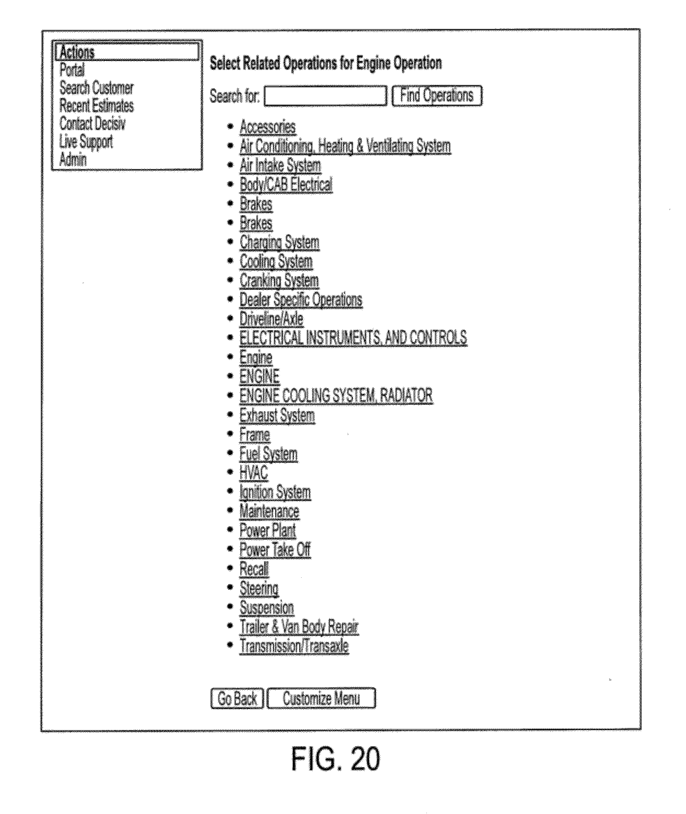

FIGS. 16-20 illustrate user interfaces provided by the platform to allow a user to create an operation. FIG. 16 illustrates a user interface that allows a user creating an operation to specify parts, parts' prices that are pulled from various sources (e.g., network, location, fleet, OEM), labor times, skill level, labor rate, description, any other related operations, specific models or engines, etc. FIG. 17 illustrates a user interface that allows the user to customizing an operation by modifying information regarding variations, parts and labor, or any other customizable information. FIGS. 18 and 19 illustrate user interfaces that allow the user to customize an operation by selecting the vehicle models and engines to which the operation is to be applied, and FIG. 20 illustrates a user interface that allow the user to customize an operation by searching and selecting related operations to be associated with the operation.

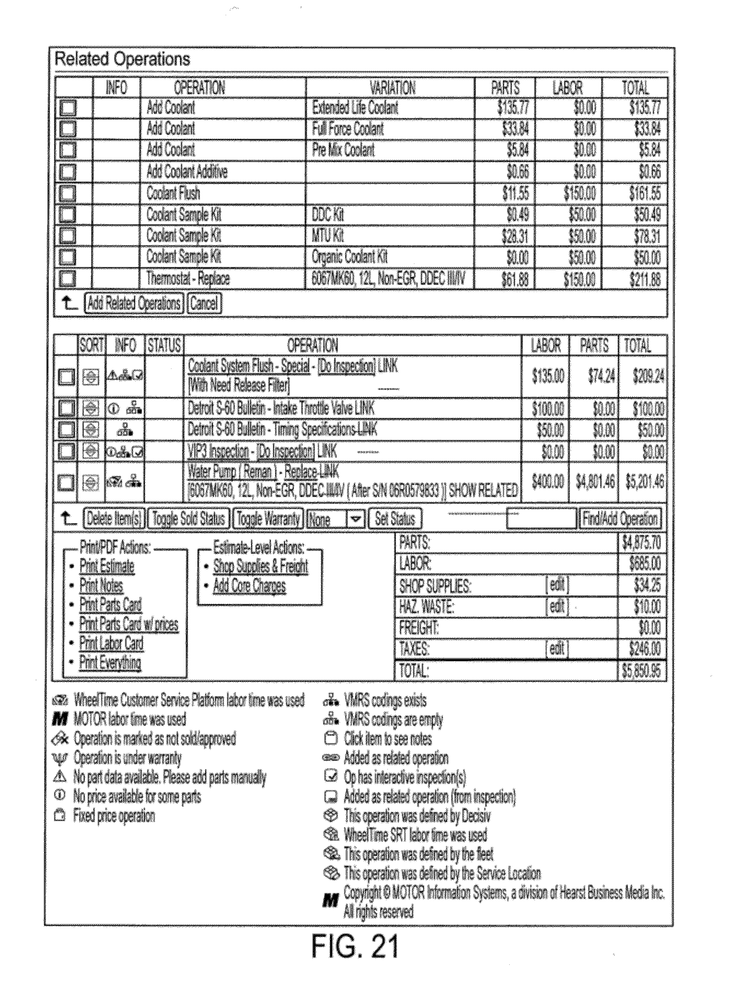

FIG. 21 illustrates an example of a user interface provided to a user upon selecting one or more operations in a service event. The platform can display related operations and variations (e.g., variations of the same related operation) associated with a selected operation along with parts estimates, labor cost, and total estimates. In this example, in response to the water pump operation specific to a variation (model) selected in relation to FIG. 15, the platform displays related operations associated with the selected water pump in database 110 that are appropriate for a water pump replacement (e.g., coolant-related operations).

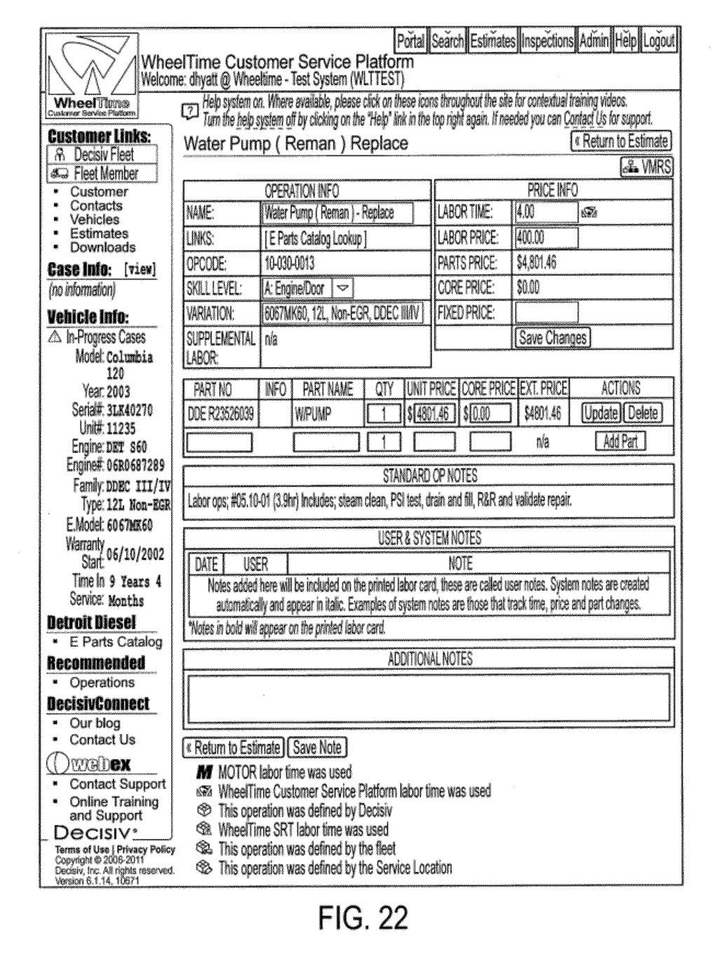

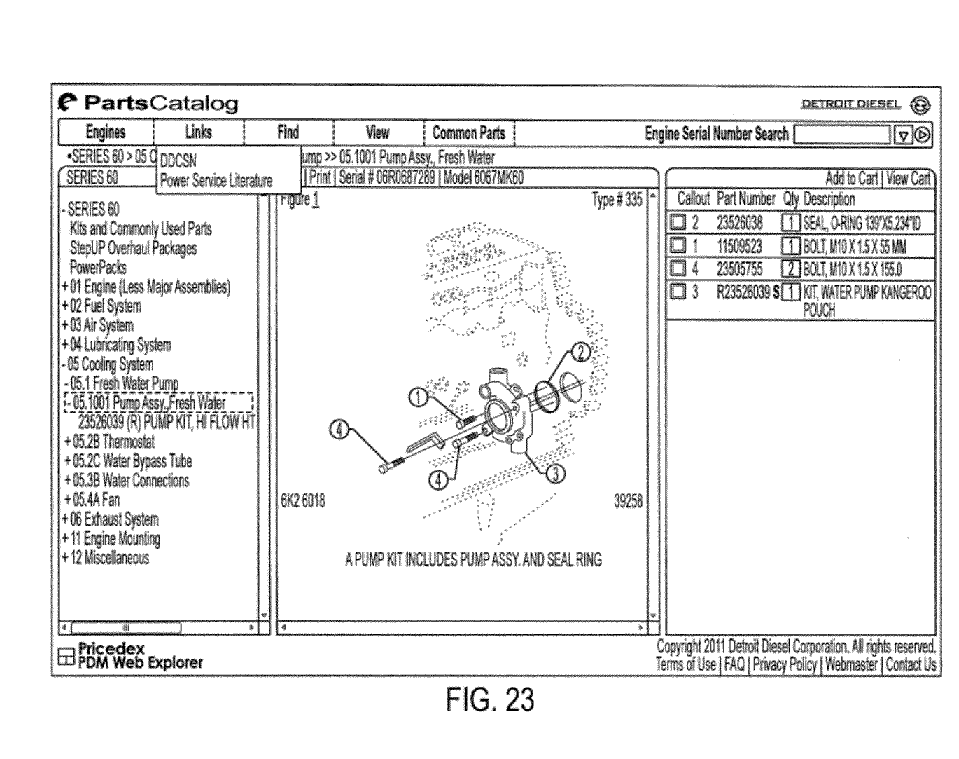

FIG. 22 illustrates an example of a detailed view of an operation provided by the platform in response to the selection of the operation. In this example, the selected operation is indicated by the “Water Pump (Reman) Replace” heading, and the detailed view displays details about the water pump operation including a live link to the OE's catalog (e.g., e Parts). Upon clicking the link the platform provides immediate access (in-context) to the correct diagram (specific to the vehicle and engine serial numbers) in the OE's catalog, external to the platform, as illustrated in FIG. 23. The user can selected the desired part(s) from the catalog at the external site, and in response to that selection the platform can pull the selected part(s) across to the platform where the part(s) can be priced based on business rules stored in the platform.

The live link provides immediate (i.e., direct) access to the correct part at the external site so that the user does not need to navigate the external site to search for the part. The platform can determine which part the user has selected at the external site by, for example, inserting session information into the live link (e.g., URL) to the OE catalog. Once the user follows the link, the external site can use the session information from the link to identify the platform as the originating site and to provide the selected part information to the platform via a pre-defined application programming interface upon receiving a checkout or other event indicating the user's intent to purchase the part. Once the platform receives the part information along with the session information from the external site (which in this embodiment occurs through a different communication pathway than the one employed by the platform to access the catalog), the platform can integrate the part information with the service event using the session information provided by the external site. This automatic integration between the platform and third party site is advantageous to the user, in that it negates the need for the user to manually enter or input part information from an external site into the platform.

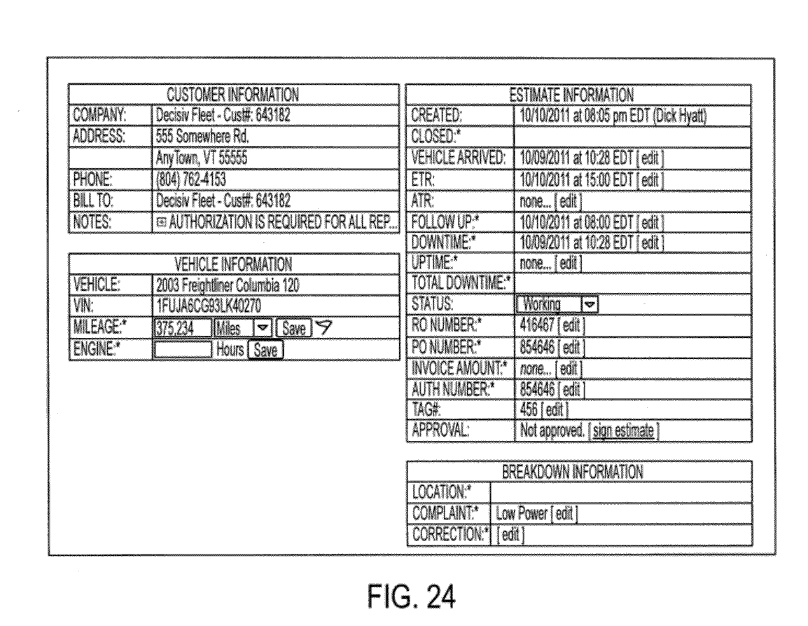

FIG. 24 illustrates an example of service event tracking provided by the platform. In this example, the platform displays two columns, the left of which displays the basic information associated with the asset (e.g., vehicle) and right of which displays the history of the service events associated with the vehicle. Each of these past service events is time-stamped and displayed on the user interface. Though this user interface the platform enables tracking of the event throughout the process, and the time stamps can be used to track key metrics and drive reports on performance.

FIGS. 25A-25B illustrate an example of a threaded communication between multiple participants via the platform. In this example, a live threaded communication (redacted to protect confidentiality of the communication) of a vehicle's telematics, service provider, fleet manager and tech support center is illustrated. For example, note the faults codes from telematics onboard diagnostics and fleet Director of Maintenance responding via email. Per each participant's user profile, each participant to a conversation can receive and reply via different communication modes (e.g., email, dashboard and/or SMS), and the platform can extract the communications and insert them into a single time-ordered thread to be stored in the service event folder.

The platform can ensure that it receives the communications irrespective of the communication mode (e.g., e-mail, SMS, etc.) by acting as an intermediary to the conversation. The platform can act as an intermediary by directing all participants' communications through the platform. In the case of a dashboard communication, the communication is entered by the user directly into a user interface provided by the platform on a particular computer or device. In the case of an e-mail or SMS, the platform can provide the participant with a platform e-mail or SMS address that is uniquely associated with the communication session (e.g., via session information incorporated into each communication). In this manner, the platform can receive and relay each communication to the intended party while extracting it for the thread, even if a user enters the communication on a computer or device that is not running the platform. Thus, all conversations can be dated, time stamped and threaded in one stream, even when they are responses using SMS or e-mail.

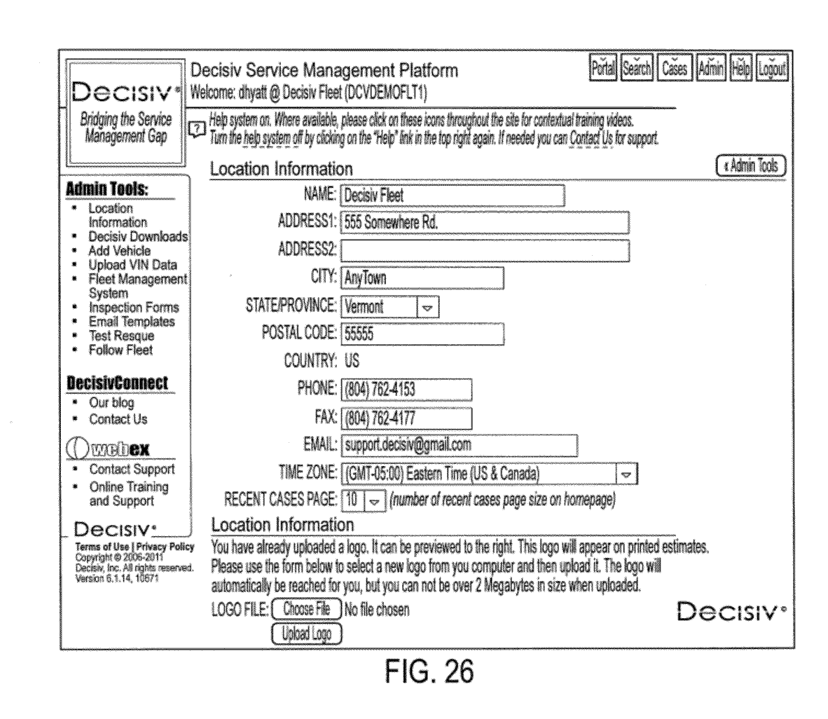

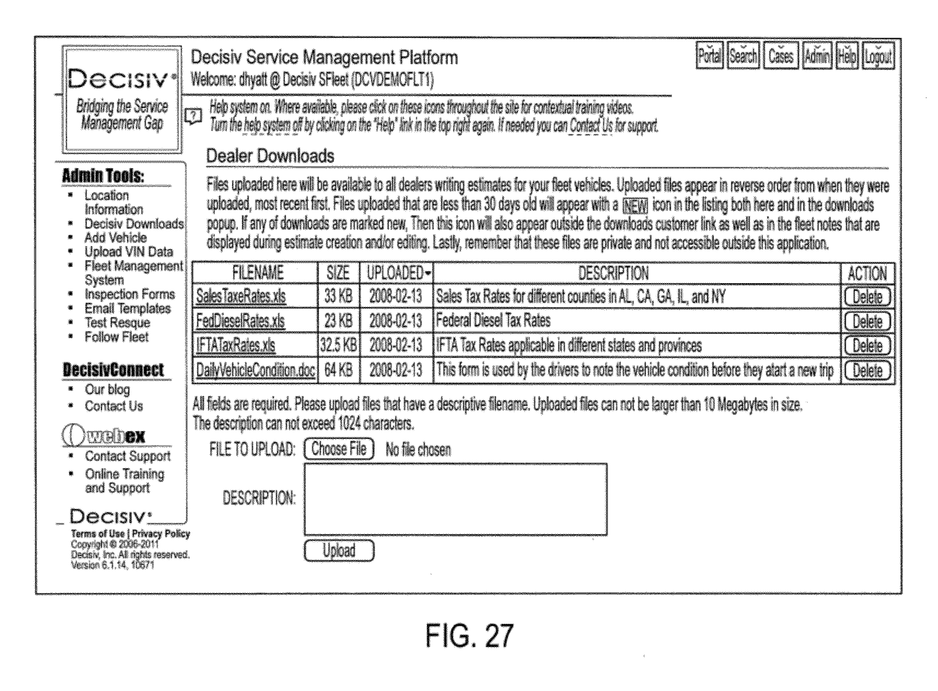

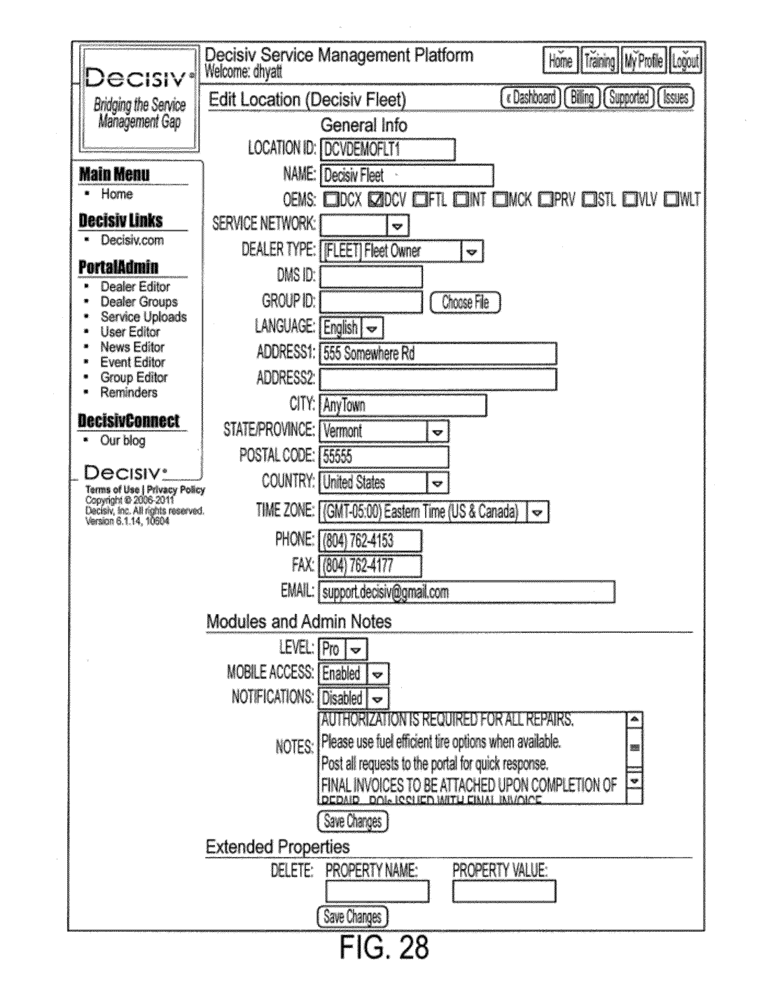

FIGS. 26-28 illustrate examples of administrator tools provided by the platform for a fleet manager. The tools allow the administrator to view and modify the fleet profile (FIG. 26), upload files that can be available for download by other participants such as dealers writing estimates for fleet vehicles (FIG. 27), and provide general fleet profile information including notes (FIG. 28).

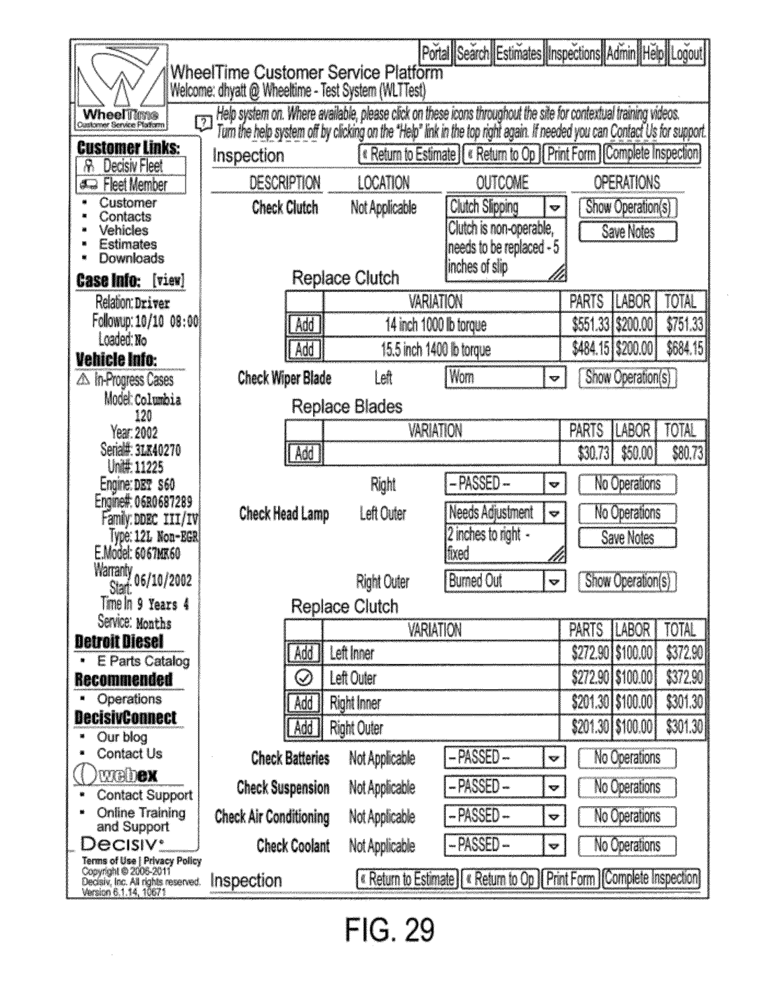

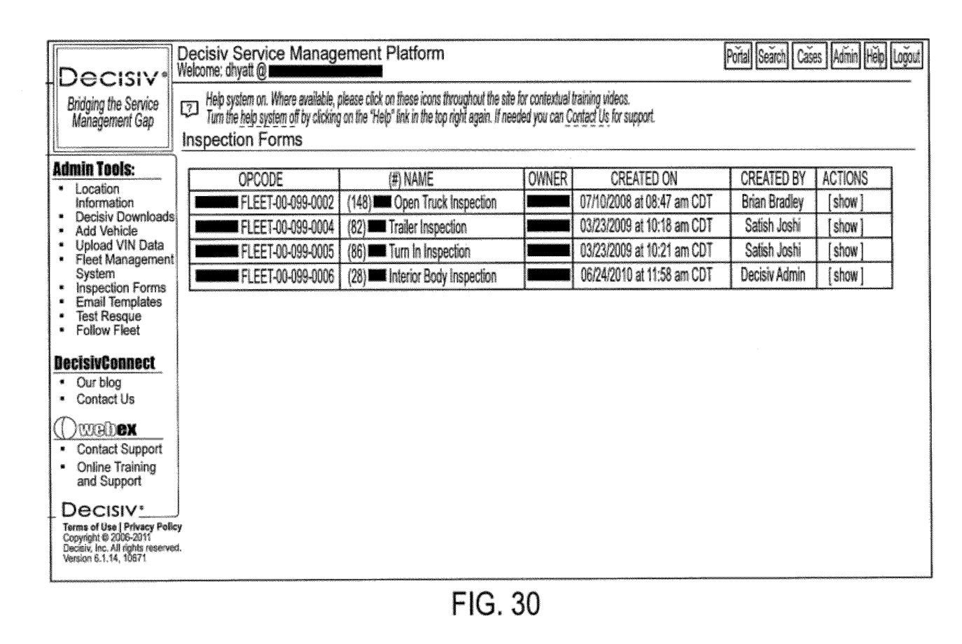

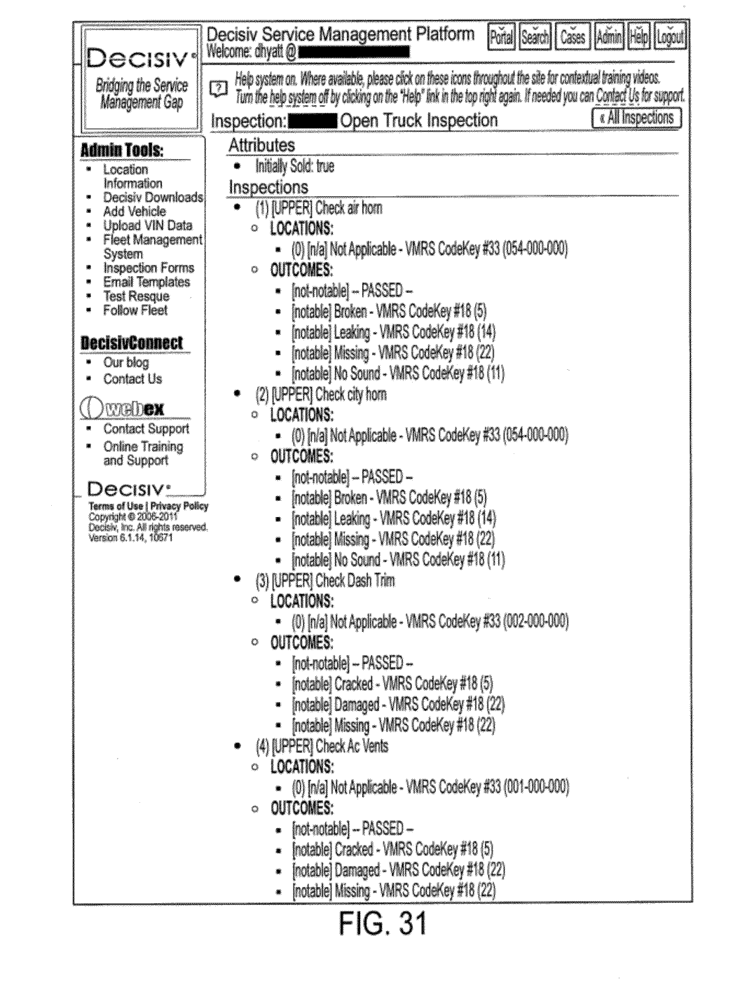

FIGS. 29-31 illustrate examples of user interfaces associated with inspections provided by the platform. FIG. 29 illustrates a user interface of an inspection form completed by a service provider during a service event. The inspection forms can be stored in the participants' profiles (e.g., a fleet profile) as shown in FIG. 30, which illustrates four inspection forms (open truck inspection, trailer inspection, turn in inspection and interior body inspection) created by a particular fleet owner. The platform can provide a user interface to allow various platform participants, such as a fleet manager, network, service provider, OEM, etc., to create inspection forms. FIG. 31 illustrates a template for the open truck inspection form depicted in FIG. 30.

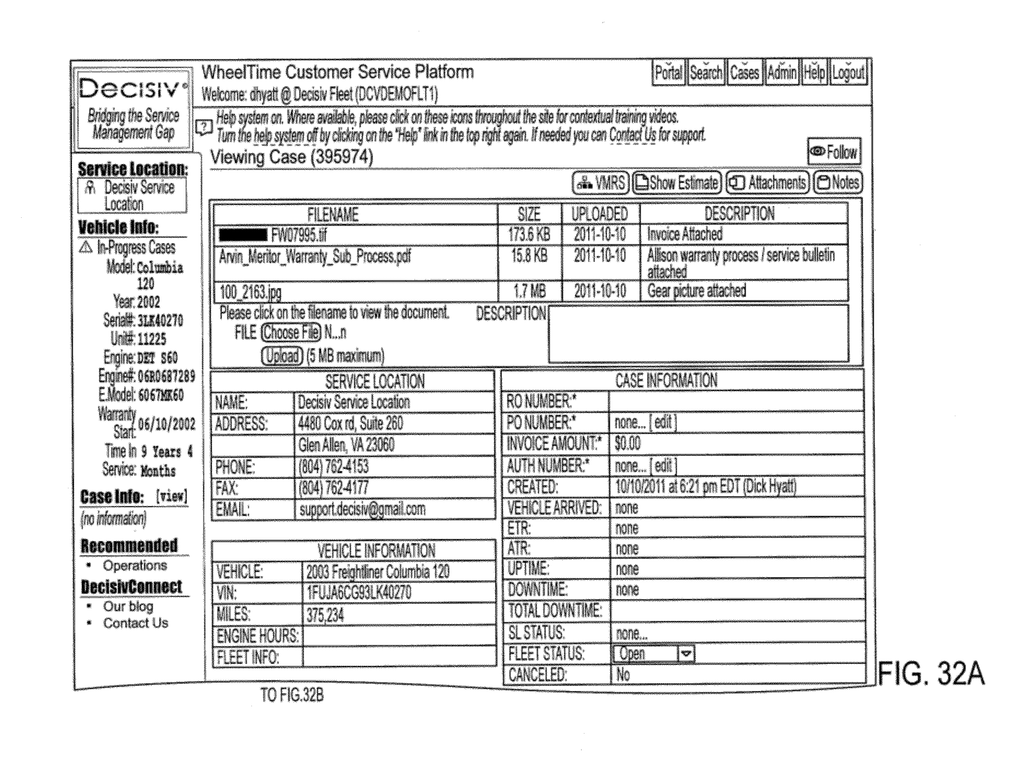

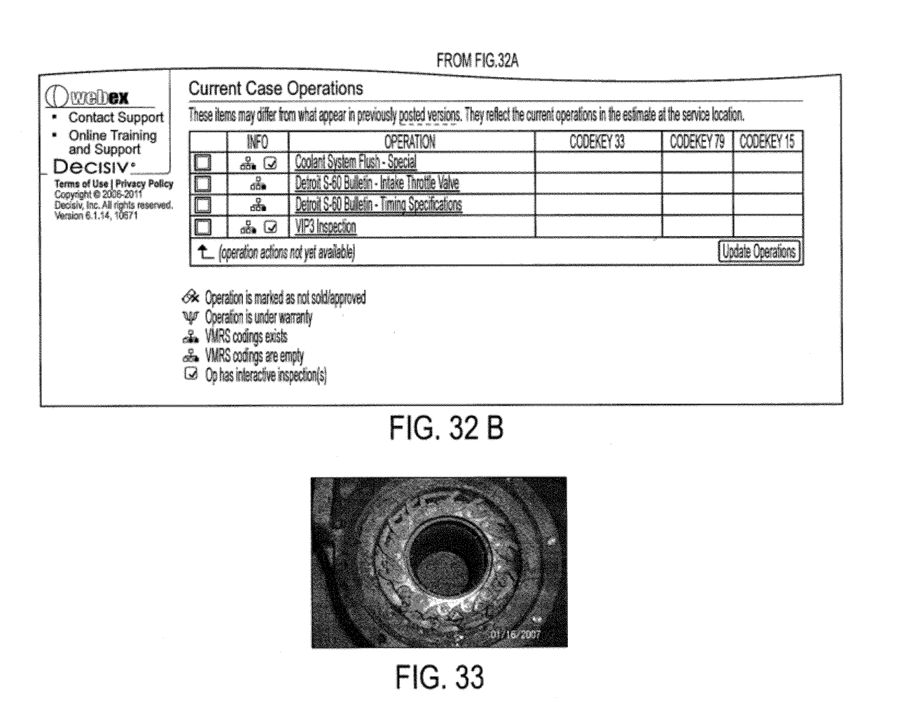

FIGS. 32A-32B illustrate an example of a service event folder provided by the platform. In this example, the service event folder includes all information associated with the service event and the subject vehicle as well as documents attached by any other party (e.g., service provider). For example, these documents can be a photo of worn gear (FIG. 33), warranty document or invoice. The service event folder can allow any party to attach and include any of these documents in the service event folder to be accessible by anyone accessing the service event folder through the platform.

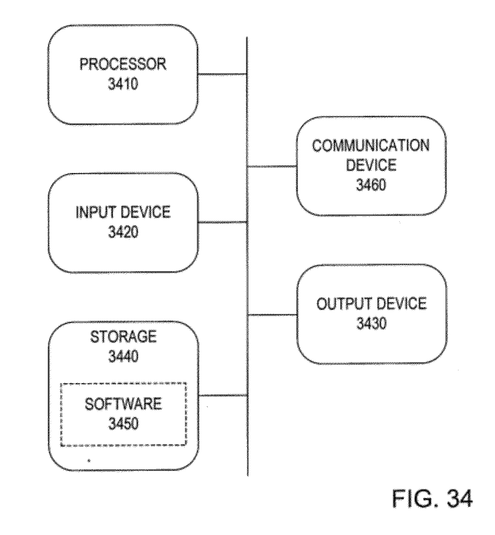

FIG. 34 illustrates an example of a computing device in accordance with one embodiment. In the embodiment illustrated in FIG. 34, the computing device may generally correspond to the computers as described above. The computing device can be any suitable type of microprocessor-based device, such as, for example, a personal computer, workstation, server or handheld computing device such as a phone or tablet. The computing device can include, for example, one or more of processor 3410, input device 3420, output device 3430, storage 3440, and communication device 3460.

Input device 3420 can be any suitable device that provides input, such as, for example, a touch screen or monitor, keyboard, mouse, or voice-recognition device. Output device 3430 can be any suitable device that provides output, such as, for example, a touch screen, monitor, printer, disk drive, or speaker.

Storage 3440 can be any suitable device the provides storage, such as, for example, an electrical, magnetic or optical memory including a RAM, cache, hard drive, CD-ROM drive, tape drive or removable storage disk. Communication device 3460 can include any suitable device capable of transmitting and receiving signals over a network, such as, for example, a network interface chip or card. The components of the computing device can be connected in any suitable manner, such as, for example, via a physical bus or wirelessly.

Software 3450, which can be stored in storage 3440 and executed by processor 3410, can include, for example, the application programming that embodies the functionality of the present disclosure (e.g., as embodied in the computers, servers and devices as described above). In some embodiments, software 3450 can include a combination of servers such as application servers and database servers.

Software 3450 can also be stored and/or transported within any computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 3440, that can contain or store programming for use by or in connection with an instruction execution system, apparatus, or device.

Software 3450 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Network 115 can be any suitable type of interconnected communication system. Network 115 can implement any suitable communications protocol and can be secured by any suitable security protocol. Network 115 can comprise network links of any suitable arrangement that can implement the transmission and reception of network signals, such as, for example, wireless network connections, T1 or T3 lines, cable networks, DSL, or telephone lines.

The computing device can implement any operating system suitable for the type of device and requirements of the application as described above. Software 3450 can be written in any suitable programming language, such as, for example, C, C++ or Java. In various embodiments, application software embodying the functionality of the present disclosure can be deployed in different configurations, such as, for example, in a client/server arrangement or through a Web browser as a Web-based application or Web service, for example.

It will be appreciated that the above description for clarity has described some embodiments of the disclosure with reference to single steps and computing devices. However, it will be apparent that any suitable distribution of functionality among each step or computing device can be used without detracting from the disclosure. For example, functionality illustrated to be performed in a single step or by a single computing device may be performed in multiple steps or by multiple computing devices. Hence, references to specific steps and computing devices may be seen as providing the described functionality rather than indicative of a strict logical or physical structure or organization.

The service management platform can be implemented in any suitable form, including hardware, software, firmware, or any combination of these. The service management platform can also be implemented partly as computer software running on one or more data processors and/or digital signal processors. The elements and components of the service management platform can be physically, functionally, and logically implemented in any suitable way. Indeed, the functionality can be implemented in a single unit, in a plurality of units, or as part of other functional units. As such, the service management platform can be implemented in a single unit or may be physically and functionally distributed between different units and processors.

For example, in one embodiment service management server 105 can comprise a single server configured to both collect data from a plurality of data sources related to the parties and the service of the assets and to determine service requirements for the assets, collect and distribute asset specific data for managing the service requirements of the assets, facilitate communication between parties to a service event, and maintain current and historical data about the service event. In another embodiment, service management server 105 can comprise first and second servers, with the first server being configured to collect the data from the plurality of data sources related to the parties and the service of the assets and the second server being configured to determine service requirements for the assets, collect and distribute asset specific data for managing the service requirements of the assets, facilitate communication between parties to a service event, and maintain current and historical data about the service.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system for managing a plurality of assets, comprising:
a database configured to store data from a plurality of data sources, each data source having data related to at least one of the plurality of assets;
a service management server to collect data from the plurality of data sources and, based on the collected data, to determine a service plan.

2. The system of claim 1, wherein the plurality of data sources comprises at least one of: a fleet device, a service provider device, an asset manufacturer device, a part manufacturer device, and a part dealer device.

3. The system of claim 2, wherein at least one of the data sources is a computer.

4. The system of claim 2, wherein at least one of the data sources is a smart phone.

5. The system of claim 1, wherein the service management server stores the collected data in the database.

6. The system of claim 1, wherein the collected data includes at least one of: maintenance records, original part identification numbers, recommended maintenance schedules, part availability, part price, estimated maintenance cost, service provider location, service provider schedule, mandatory inspection requirements, and manufacturer maintenance procedures.

7. The system of claim 1, wherein the plurality of assets are vehicles within a fleet of vehicles.

8. The system of claim 1, wherein the service management server directs a user to one of the plurality of data sources via a first communication pathway over a network and receives from the one data source via a second communication pathway over the network data selected by the user at the one data source.

9. The system of claim 1, wherein the service management server extracts communications from different modes of communication and inserts the extracted communications into a single time-ordered thread.

10. A system for managing maintenance and inspection of a plurality of vehicles, comprising:
a service provider computer to store and provide data including at least one of estimated maintenance cost, service provider location, and service provider schedule;
a vehicle manufacturer computer to store and provide data including at least one of original part identification numbers, recommended maintenance schedules, and maintenance procedures;
a part manufacturer computer to store and provide data including at least one of part descriptions, part installation instructions, and part compatibility;
a part dealer computer to store and provide data including at least one of part cost, part availability, part location, and part shipping time;
a service management server to collect data from at least one of the service provider computer, the vehicle manufacturer computer, the part manufacturer computer, and the part dealer computer, and, based on the collected data, to determine a service activity for at least one of the plurality of vehicles, wherein the service activity includes at least one of a repair or an inspection; and
a fleet computer through which a user can access the service management server to determine if any service activities should be performed.

11. The system of claim 10, wherein the determined service activity includes identifying a service provider.

12. The system of claim 11, wherein the service provider is determined based on at least one of a service provider location and an estimated service cost.

13. A system for managing a plurality of assets and a plurality of parties related to the assets, comprising:
a plurality of data sources with information related to the parties and the service of the assets;
a service management server configured to collect the data from the plurality of data sources related to the parties and the service of the assets and configured to determine service requirements for the assets, collect and distribute asset specific data for managing the service requirements of the assets, facilitate communication between parties to a service event, and maintain current and historical data about the service event.

14. The system of claim 13, wherein the service management server comprises first and second servers, the first server being configured to collect the data from the plurality of data sources related to the parties and the service of the assets and the second server being configured to determine service requirements for the assets, collect and distribute asset specific data for managing the service requirements of the assets, facilitate communication between parties to a service event, and maintain current and historical data about the service event.

15. The system of claim 13, wherein the information related to the parties and the service of the assets comprises a series of profiles managed by the system that include one or more of asset owner, maintenance manager, service provider, asset manufacturer and component manufacturer.

16. The system of claim 15, wherein the profiles contain data tags for key data items, the data items including part descriptions, part numbers, labor operations, labor descriptions, pricing information, asset identifying information, component identifying information, asset locations, service providers, manufacturers, asset owners and maintenance managers.

17. The system of claim 16, wherein the system is configured to use the data tags at the service event to determine an appropriate action or service to be performed.

18. The system of claim 16, wherein the system is configured to use the profiles and data tags to facilitate access to pertinent information related to the service event or delivery of pertinent information from the information source to the service event.

19. The system of claim 14, wherein the second server is further configured to issue alerts or notifications related to the service events that are personalized to the service events, devices or participants.

20. The system of claim 13, wherein the service events managed by the system include maintenance, repair and inspection.

21. The system of claim 20, wherein the system is configured to prescribe inspections that are specific to the asset, component, asset owner or manufacturer and include step by step action, possible results and maintenance, repair or inspection actions to be taken.

22. The system of claim 21, wherein the prescription of inspections may be provided on a computer, laptop, smart phone, SMS to cell phone or tablet.

23. The system of claim 13, wherein the system is configured to initiate service events based on initiation by an asset owner, access to the asset owner's asset management system;
input to the system from a telematics device on an asset; fault or other information provided to the system; point of service identification through scanning of asset identification markers or other identifiers; and in-context data from the asset pulled into the system.

24. The system of claim 23, wherein the other identifier is an RFID tag.
